(19) United States
(12) Patent Application Publication
(10) Pub. No.: US 2026/0031930 A1
(43) Pub. Date: Jan. 29, 2026

(54) CONTROL INFORMATION ASSOCIATIONS FOR POLAR CODES

(71) Applicant: QUALCOMM Incorporated, San Diego, CA (US)

(72) Inventors: Wei YANG, San Diego, CA (US); Gabi SARKIS, San Diego, CA (US); Mahmoud TAHERZADEH BOROUJENI, San Diego, CA (US); Mostafa KHOSHNEVISAN, San Diego, CA (US); Shravan Kumar Reddy GARLAPATI, San Diego, CA (US); Jing JIANG, San Diego, CA (US)

(21) Appl. No.: 18/786,106

(22) Filed: Jul. 26, 2024

(51) Int. Cl. H04L 1/00; H04L 1/1812

(52) U.S. Cl. CPC H04L 1/0057; H04L 1/1819

(57) ABSTRACT

Some examples of the techniques described herein may exploit one or more fields in a polar decoder by treating the fields as frozen bits. For instance, control information field mapping to polar codes may be enhanced, where control information bits may be mapped to the polar code following a reliability order of a set of information locations (e.g., bit indices). A UE or network entity may utilize an ordering to improve performance. For example, the location of the bits that are likely to have a particular value or that are unlikely to change over time (e.g., that have a relatively higher time correlation) may be exploited. In some approaches, control information fields with values that are relatively strongly correlated in time, or control information fields with a relatively strong bias (a priori) towards values may be placed at or near the beginning of a control information format.

### FIELD OF TECHNOLOGY

The following relates to wireless communications, including control information associations for polar codes.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method by a user equipment (UE) is described. The method may include communicating a first control information field with a network entity, where the first control information field is ordered in a control information format based on a first reliability of a first bit index of a polar code associated with the first control information field and communicating a second control information field with the network entity, where the second control information field is ordered in the control information format based on a second reliability of a second bit index of the polar code associated with the second control information field, and where the first bit index and the second bit index are included in a set of multiple indices of the polar code that is ordered in an ascending or descending order of reliability.

A UE is described. The UE may include one or more memories storing processor executable code, and one or more processors coupled with the one or more memories. The one or more processors may individually or collectively be operable to execute the code to cause the UE to communicate a first control information field with a network entity, where the first control information field is ordered in a control information format based on a first reliability of a first bit index of a polar code associated with the first control information field and communicate a second control information field with the network entity, where the second control information field is ordered in the control information format based on a second reliability of a second bit index of the polar code associated with the second control information field, and where the first bit index and the second bit index are included in a set of multiple indices of the polar code that is ordered in an ascending or descending order of reliability.

Another UE is described. The UE may include means for communicating a first control information field with a network entity, where the first control information field is ordered in a control information format based on a first reliability of a first bit index of a polar code associated with the first control information field and means for communicating a second control information field with the network entity, where the second control information field is ordered in the control information format based on a second reliability of a second bit index of the polar code associated with the second control information field, and where the first bit index and the second bit index are included in a set of multiple indices of the polar code that is ordered in an ascending or descending order of reliability.

A non-transitory computer-readable medium storing code is described. The code may include instructions executable by one or more processors to communicate a first control information field with a network entity, where the first control information field is ordered in a control information format based on a first reliability of a first bit index of a polar code associated with the first control information field and communicate a second control information field with the network entity, where the second control information field is ordered in the control information format based on a second reliability of a second bit index of the polar code associated with the second control information field, and where the first bit index and the second bit index are included in a set of multiple indices of the polar code that is ordered in an ascending or descending order of reliability.

Some examples of the method, UEs, and non-transitory computer-readable medium described herein may further include operations, features, means, or instructions for receiving a configuration from the network entity, where the configuration indicates an ordering of the first control information field and the second control information field in the control information format.

In some examples of the method, UEs, and non-transitory computer-readable medium described herein, the configuration indicates a probability model associated with the first control information field, the probability model indicating a probability for each respective bit of the first control information field to may have a value, or a conditional probability that the first control information field may have a same value as a previous first control information field.

In some examples of the method, UEs, and non-transitory computer-readable medium described herein, the ordering of the first control information field and the second control information field differs from a previous ordering of a previous first control information field and a previous second control information field indicated by a previous configuration.

In some examples of the method, UEs, and non-transitory computer-readable medium described herein, the previous configuration may be received from another network entity that may be different from the network entity from which the configuration may be received.

In some examples of the method, UEs, and non-transitory computer-readable medium described herein, the first reliability of the first bit index may be less than the second reliability of the second bit index, the first control information field indicates a control information format indicator, a modulation and coding scheme (MCS), a time domain resource allocation (TDRA), a frequency domain resource allocation (FDRA), a transmit power control (TPC) value, hybrid automatic repeat request (HARQ) timing information, a physical uplink control channel (PUCCH) resource indicator, a sounding reference signal (SRS) request, an antenna port indicator, or a demodulation reference signal (DMRS) sequence indicator, and the second control information field indicates a redundancy version (RV), a new data indicator (NDI), a HARQ process number, or a downlink assignment index.

In some examples of the method, UEs, and non-transitory computer-readable medium described herein, de-mapping the first control information field from the first bit index and de-mapping the second control information field from the second bit index, where the first control information field may be ordered before the second control information field in the control information format, and the first reliability of the first bit index may be less than the second reliability of the second bit index.

Some examples of the method, UEs, and non-transitory computer-readable medium described herein may further include operations, features, means, or instructions for mapping the first control information field to the first bit index and mapping the second control information field to the second bit index, where the first control information field may be ordered before the second control information field in the control information format, and the first reliability of the first bit index may be less than the second reliability of the second bit index.

In some examples of the method, UEs, and non-transitory computer-readable medium described herein, the first control information field includes a set of multiple bits and the method, apparatuses, and non-transitory computer-readable medium may include further operations, features, means, or instructions for de-mapping each respective bit of the set of multiple bits from respective indices of a subset of the set of multiple indices, where the respective indices of the subset of the set of multiple indices may be associated with consecutive reliabilities in the ascending or descending order of reliability.

In some examples of the method, UEs, and non-transitory computer-readable medium described herein, the first control information field includes a set of multiple bits and the method, apparatuses, and non-transitory computer-readable medium may include further operations, features, means, or instructions for mapping each respective bit of the set of multiple bits to respective indices of a subset of the set of multiple indices, where the respective indices of the subset of the set of multiple indices may be associated with consecutive reliabilities in the ascending or descending order of reliability.

In some examples of the method, UEs, and non-transitory computer-readable medium described herein, each respective bit of the set of multiple bits may be mapped in an order of the consecutive reliabilities or in an order of the subset of the set of multiple indices.

Some examples of the method, UEs, and non-transitory computer-readable medium described herein may further include operations, features, means, or instructions for sending an indication of a capability of the UE to utilize the polar code that may be ordered in the ascending or descending order of reliability, where communicating the first control information field and communicating the second control information field may be performed based on the capability of the UE.

A method by a network entity is described. The method may include communicating a first control information field with a UE, where the first control information field is ordered in a control information format based on a first reliability of a first bit index of a polar code associated with the first control information field and communicating a second control information field with the UE, where the second control information field is ordered in the control information format based on a second reliability of a second bit index of the polar code associated with the second control information field, and where the first bit index and the second bit index are included in a set of multiple indices of the polar code that is ordered in an ascending or descending order of reliability.

A network entity is described. The network entity may include one or more memories storing processor executable code, and one or more processors coupled with the one or more memories. The one or more processors may individually or collectively be operable to execute the code to cause the network entity to communicate a first control information field with a UE, where the first control information field is ordered in a control information format based on a first reliability of a first bit index of a polar code associated with the first control information field and communicate a second control information field with the UE, where the second control information field is ordered in the control information format based on a second reliability of a second bit index of the polar code associated with the second control information field, and where the first bit index and the second bit index are included in a set of multiple indices of the polar code that is ordered in an ascending or descending order of reliability.

Another network entity is described. The network entity may include means for communicating a first control information field with a UE, where the first control information field is ordered in a control information format based on a first reliability of a first bit index of a polar code associated with the first control information field and means for communicating a second control information field with the UE, where the second control information field is ordered in the control information format based on a second reliability of a second bit index of the polar code associated with the second control information field, and where the first bit index and the second bit index are included in a set of multiple indices of the polar code that is ordered in an ascending or descending order of reliability.

A non-transitory computer-readable medium storing code is described. The code may include instructions executable by one or more processors to communicate a first control information field with a UE, where the first control information field is ordered in a control information format based on a first reliability of a first bit index of a polar code associated with the first control information field and communicate a second control information field with the UE, where the second control information field is ordered in the control information format based on a second reliability of a second bit index of the polar code associated with the second control information field, and where the first bit index and the second bit index are included in a set of multiple indices of the polar code that is ordered in an ascending or descending order of reliability.

Some examples of the method, network entities, and non-transitory computer-readable medium described herein may further include operations, features, means, or instructions for sending a configuration to the UE, where the configuration indicates an ordering of the first control information field and the second control information field in the control information format.

In some examples of the method, network entities, and non-transitory computer-readable medium described herein, the configuration indicates a probability model associated with the first control information field, the probability model indicating a probability for each respective bit of the first control information field to may have a value, or a conditional probability that the first control information field may have a same value as a previous first control information field.

Some examples of the method, network entities, and non-transitory computer-readable medium described herein may further include operations, features, means, or instructions for determining the probability model based on a set of multiple values of previous first control information fields.

In some examples of the method, network entities, and non-transitory computer-readable medium described herein, the ordering of the first control information field and the second control information field differs from a previous ordering of a previous first control information field and a previous second control information field indicated by a previous configuration.

In some examples of the method, network entities, and non-transitory computer-readable medium described herein, de-mapping the first control information field from the first bit index and de-mapping the second control information field from the second bit index, where the first control information field may be ordered before the second control information field in the control information format, and the first reliability of the first bit index may be less than the second reliability of the second bit index.

Some examples of the method, network entities, and non-transitory computer-readable medium described herein may further include operations, features, means, or instructions for mapping the first control information field to the first bit index and mapping the second control information field to the second bit index, where the first control information field may be ordered before the second control information field in the control information format, and the first reliability of the first bit index may be less than the second reliability of the second bit index.

In some examples of the method, network entities, and non-transitory computer-readable medium described herein, the first control information field includes a set of multiple bits and the method, apparatuses, and non-transitory computer-readable medium may include further operations, features, means, or instructions for de-mapping each respective bit of the set of multiple bits from respective indices of a subset of the set of multiple indices, where the respective indices of the subset of the set of multiple indices may be associated with consecutive reliabilities in the ascending or descending order of reliability.

In some examples of the method, network entities, and non-transitory computer-readable medium described herein, the first control information field includes a set of multiple bits and the method, apparatuses, and non-transitory computer-readable medium may include further operations, features, means, or instructions for mapping each respective bit of the set of multiple bits to respective indices of a subset of the set of multiple indices, where the respective indices of the subset of the set of multiple indices may be associated with consecutive reliabilities in the ascending or descending order of reliability.

In some examples of the method, network entities, and non-transitory computer-readable medium described herein, each respective bit of the set of multiple bits may be mapped in an order of the consecutive reliabilities or in an order of the subset of the set of multiple indices.

Some examples of the method, network entities, and non-transitory computer-readable medium described herein may further include operations, features, means, or instructions for receiving an indication of a capability of the UE to utilize the polar code that may be ordered in the ascending or descending order of reliability, where communicating the first control information field and communicating the second control information field may be performed based on the capability of the UE.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports control information associations for polar codes in accordance with one or more aspects of the present disclosure.

FIG. 2 shows an example of a wireless communications system that supports control information associations for polar codes in accordance with one or more aspects of the present disclosure.

FIG. 3 shows an example of a signal flow diagram that supports control information associations for polar codes in accordance with one or more aspects of the present disclosure.

FIG. 4 shows an example of a timing diagram that supports control information associations for polar codes in accordance with one or more aspects of the present disclosure.

FIG. 5 shows an example of a graph that supports control information associations for polar codes in accordance with one or more aspects of the present disclosure.

FIG. 6 shows an example of a process flow that supports control information associations for polar codes in accordance with one or more aspects of the present disclosure.

FIGS. 7 and 8 show block diagrams of devices that support control information associations for polar codes in accordance with one or more aspects of the present disclosure.

FIG. 9 shows a block diagram of a communications manager that supports control information associations for polar codes in accordance with one or more aspects of the present disclosure.

FIG. 10 shows a diagram of a system including a device that supports control information associations for polar codes in accordance with one or more aspects of the present disclosure.

FIGS. 11 and 12 show block diagrams of devices that support control information associations for polar codes in accordance with one or more aspects of the present disclosure.

FIG. 13 shows a block diagram of a communications manager that supports control information associations for polar codes in accordance with one or more aspects of the present disclosure.

FIG. 14 shows a diagram of a system including a device that supports control information associations for polar codes in accordance with one or more aspects of the present disclosure.

FIGS. 15 through 18 show flowcharts illustrating methods that support control information associations for polar codes in accordance with one or more aspects of the present disclosure.

### DETAILED DESCRIPTION

Some wireless communications systems utilize a polar code for encoding information. For example, a polar code may be utilized to encode uplink control information (UCI), downlink control information (DCI), or sidelink control information (SCI). For DCI, UCI, or SCI, for instance, a receiving device (e.g., a user equipment (UE) or a network entity) may obtain or utilize information regarding one or more fields before decoding. In some aspects, one or more fields in the DCI may have a value with a probability before decoding. For example, a bit of the DCI may have an associated probability of having a value before the DCI is communicated or decoded. In some aspects, statistical information about a field may be available (e.g., a new data indicator (NDI) in DCI may have a higher probability of indicating new data than retransmitted data). Based on field logs, for example, the values one or more fields for uplink or downlink grants may tend to remain constant over a consecutive set of slots. Examples of fields may include, but are not limited to, a modulation and coding scheme (MCS), a frequency domain resource allocation (FDRA), a time domain resource allocation (TDRA), and a physical downlink shared channel (PDSCH) to hybrid automatic repeat request (HARQ) timing (e.g., a K1 value), among other examples. In some deployment scenarios, more than half of the actual DCI payload may be assumed prior to decoding (based on a previously decoded DCI, for instance). However, DCI and coding design may fail to exploit such information regarding bit values, or may fail to achieve a gain based on the information regarding bit values.

Some examples of the techniques described herein may exploit one or more fields in a polar decoder by treating the fields as frozen bits. For instance, control information (e.g., DCI) field mapping to polar codes may be enhanced to exploit the information regarding bit values. A UE or network entity may exploit the information to improve performance. For example, the location of the bits that are likely to have a particular value or that are unlikely to change over time (e.g., that have a relatively higher time correlation) may be exploited.

In some approaches, the control information (e.g., DCI, UCI, or SCI) fields with values that are relatively strongly correlated in time (e.g., where the value of the field in a slot may likely imply the value of the same field in the next slot), or control information fields with a relatively strong bias (a priori) towards values (e.g., certain values or particular values) may be placed at or near the beginning of the control information (e.g., DCI, UCI, or SCI) format. In some cases, an approximate 1.5 decibel (dB) gain in SNR may be achieved by moving these bits to the beginning of the control information (e.g., DCI).

In some approaches, control information bits a₁, a₂, . . . , a_{K} (including CRC bits, for instance, where K denotes a bit index) may be mapped to the polar code following a reliability order of the set of information locations (e.g., bit indices). For instance, the first bit of control information (e.g., UCI or DCI) may be mapped to the synthetic channel with least reliability (among the top K reliable synthetic channels of a polar code), and the last bit of control information may be mapped to the synthetic channel with the highest reliability. The way the DCI is mapped to the polar codes may achieve another approximate 1.5 dB gain in SNR via the DCI to polar code mapping.

Aspects of the disclosure are initially described in the context of wireless communications systems. Aspects of the disclosure are also described in the context of a signal flow diagram, a timing diagram, and a graph. Aspects of the disclosure are initially described in the context of a process flow. Aspects of the disclosure are further illustrated by and described with reference to apparatus diagrams, system diagrams, and flowcharts that relate to control information associations for polar codes.

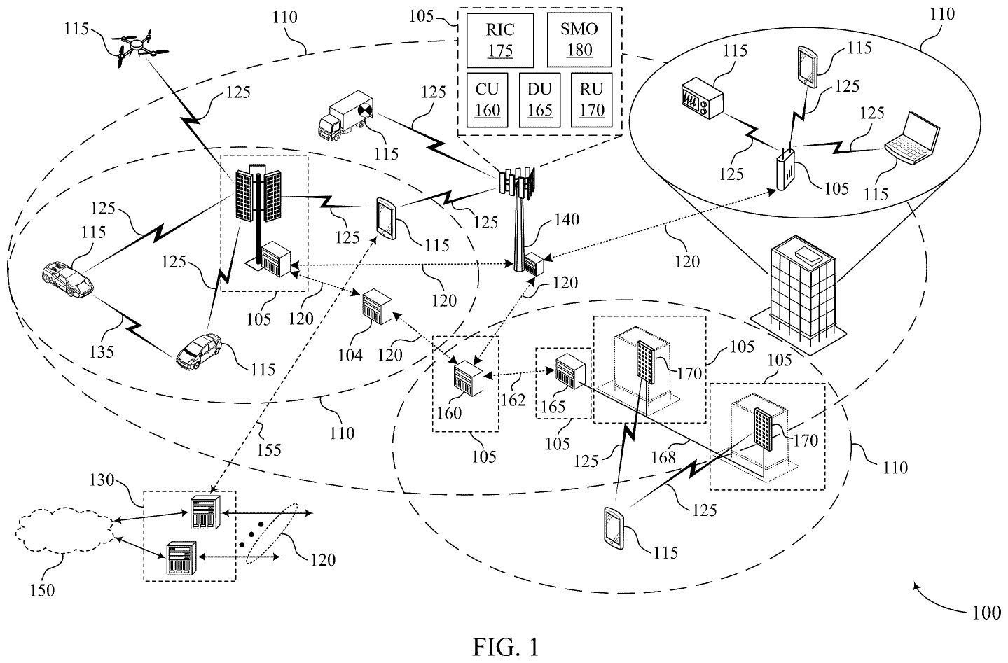

FIG. 1 shows an example of a wireless communications system 100 that supports control information associations for polar codes in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (cMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some wireless communications systems utilize a polar code for encoding information. For example, a polar code may be utilized to encode UCI, DCI, or SCI. For DCI, UCI, or SCI, for instance, a receiving device (e.g., a UE 115 or a network entity 105) may obtain or utilize information regarding one or more fields before decoding. DCI may be control information communicated from a network entity 105 to a UE 115 or via a downlink channel. UCI may be control information communicated from a UE 115 to a network entity 105 or via an uplink channel. SCI may be control information communicated between devices (e.g., between UEs 115) or via a sidelink channel. SCI may include control information similar to DCI or UCI for sidelink communications (e.g., UE-to-UE communications). In some aspects, one or more fields in the control information may have a value with a probability before decoding. For example, a bit of the DCI may have an associated probability of having a value before the DCI is communicated or decoded. In some aspects, statistical information about a field may be available (e.g., an NDI) in DCI may have a higher probability of indicating new data than retransmitted data). Based on field logs, for example, the values one or more fields for uplink or downlink grants may tend to remain constant over a consecutive set of slots (e.g., may have a relatively high correlation over time). Examples of fields may include, but are not limited to, an MCS, an FDRA, a TDRA, and a PDSCH to HARQ timing (e.g., a K1 value), among other examples. In some deployment scenarios, more than half of the actual DCI payload may be assumed prior to decoding (based on a previously decoded DCI, for instance). However, DCI and coding design may fail to exploit such information regarding bit values, or may fail to achieve a gain based on the information regarding bit values.

Some examples of the techniques described herein may exploit one or more fields in a polar decoder by treating the fields as frozen bits. For instance, control information (e.g., DCI, UCI, or SCI) field mapping to polar codes may be enhanced to exploit the information regarding bit values. A UE 115 or network entity 105 may exploit the information to improve performance. For example, the location of the bits that are likely to have a particular value or that are unlikely to change over time (e.g., that have a relatively higher time correlation) may be exploited. In some approaches, the control information (e.g., DCI, UCI, or SCI) fields with values that are relatively strongly correlated in time (e.g., where the value of the field in a slot may likely imply the value of the same field in the next slot), or control information fields with a relatively strong bias (a priori) towards values (e.g., certain values or particular values) may be placed at or near the beginning of the control information (e.g., DCI, UCI, or SCI) format. In some cases, an approximate 1.5 dB gain in SNR may be achieved by moving these bits to the beginning of the control information (e.g., DCI).

In some approaches, control information bits a₁, a₂, . . . , a_{K} (including CRC bits, for instance) may be mapped to the polar code following a reliability order of the set of information locations. For instance, the first bit of control information (e.g., UCI or DCI) may be mapped to the synthetic channel with least reliability (among the top K reliable synthetic channels of a polar code), and the last bit of control information may be mapped to the synthetic channel with the highest reliability. The way the DCI is mapped to the polar codes may achieve another approximate 1.5 dB gain in SNR via the DCI to polar code mapping.

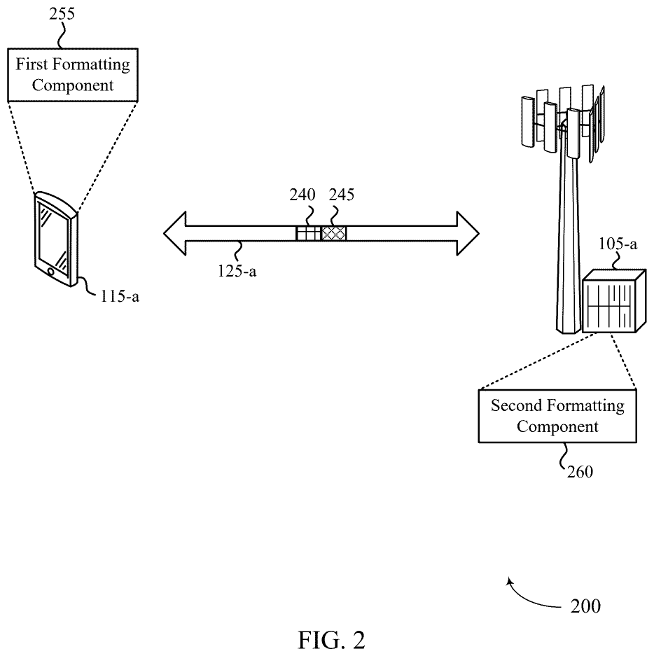

FIG. 2 shows an example of a wireless communications system 200 that supports control information associations for polar codes in accordance with one or more aspects of the present disclosure. In some examples, aspects of the wireless communications system 200 may implement or be implemented by aspects of the wireless communications system 100. For example, the wireless communications system 200 may include a UE 115-a, which may be an example of the UE 115 described with reference to FIG. 1. Additionally, or alternatively, the wireless communications system 200 may include a network entity 105-a, which may be an example of the network entity 105 described with reference to FIG. 1.

The UE 115-a may communicate with the network entity 105-a using a link 125-a, which may be an example of a communication link 125 described with respect to FIG. 1. The link 125-a may include a bi-directional link that enables uplink or downlink network communications. For example, the UE 115-a may transmit one or more uplink transmissions, such as uplink control signals or uplink data signals, to the network entity 105-a using the link 125-a, or the network entity 105-a may transmit one or more downlink transmissions, such as downlink control signals or downlink data signals, to the UE 115-a using the link 125-a. As used herein, the term “communication” and variations thereof may denote transmission, reception, or a combination thereof. For example, the UE 115-a may communicate by transmitting a signal to the network entity 105-a, may communicate by receiving a signal from the network entity 105-a, or a combination of both.

In some examples, the UE 115-a may include a first formatting component 255. The first formatting component 255 may be implemented in hardware (e.g., circuitry) or a combination of hardware and instructions (e.g., a processor with instructions). The first formatting component 255 may perform one or more encoding, decoding, mapping, or de-mapping operations. For instance, the first formatting component 255 may perform polar encoding, polar decoding, bit mapping, bit de-mapping, resource mapping (e.g., mapping one or more fields to one or more time or frequency resources, such as TTIs, slots, resource elements (REs), RBs, frequency bands, or OFDM symbols, among other examples), or resource de-mapping (e.g., de-mapping one or more fields from one or more time or frequency resources, such as TTIs, slots, REs, RBs, frequency bands, or OFDM symbols, among other examples).

In some examples, the network entity 105-a may include a second formatting component 260. The second formatting component 260 may be implemented in hardware (e.g., circuitry) or a combination of hardware and instructions (e.g., a processor with instructions). The second formatting component 260 may perform one or more encoding, decoding, mapping, or de-mapping operations. For instance, the second formatting component 260 may perform polar encoding, polar decoding, bit mapping, bit de-mapping, resource mapping (e.g., mapping one or more fields to one or more time or frequency resources, such as TTIs, slots, REs, RBs, frequency bands, or OFDM symbols, among other examples), or resource de-mapping (e.g., de-mapping one or more fields from one or more time or frequency resources, such as TTIs, slots, REs, RBs, frequency bands, or OFDM symbols, among other examples).

Control information is information for controlling one or more aspects of communication (e.g., communication between the UE 115-a and the network entity 105-a). DCI may be control information communicated from the network entity 105-a to the UE 115-a. UCI may be control information communicated from the UE 115-a to the network entity 105-a. Examples of control information fields (e.g., DCI fields) may include a control information format indicator (e.g., DCI format indicator), an MCS, a TDRA, an FDRA, a transmit power control (TPC) value, HARQ timing information, a physical uplink control channel (PUCCH) resource indicator, a sounding reference signal (SRS) request, an antenna port indicator, or a demodulation reference signal (DMRS) sequence indicator, a redundancy version (RV), an NDI, a HARQ process number, or a downlink assignment index.

Some control information (e.g., DCI, UCI, or SCI) fields may have a relatively higher probability (e.g., greater than 55%, 65%, 75%, 85%, 90%, or 95%, among other examples) of repeating a same value over time (e.g., over slots) or of having bias to a value (a priori). As used herein, a field having a bias to a value may denote that the field may be more likely to have one value than another value (e.g., more likely with at least a probability, such as 50.5%, 51%, 55%, 60%, 70%, 80%, or another probability). For instance, bits in some control fields may have a greater probability of being equal to zero than equal to one, and thus, the bits may have a bias to zero. Examples of control information fields that may have a relatively higher probability of repeating a same value over time (e.g., a strong correlation over time) or of having bias to a value (a priori) may include a control information format indicator (e.g., DCI format indicator), an MCS, a TDRA, an FDRA, a TPC value, HARQ timing information, a PUCCH resource indicator, an SRS request, an antenna port indicator, or a DMRS sequence indicator, among other examples.

Some control information fields may have a relatively lower probability (e.g., 50%, between 50% and 65%, or between 45% and 55%, among other examples) of repeating a same value over time (e.g., over slots) or of having bias to a value (a priori). For instance, a nominal case (in which there is a lower probability of repeating the same value) may have a probability of 50% for a value of zero or a value of one. In this case, there is a 50% probability that a next bit will be the same as a previous bit, and a 50% probability that the next bit will be different from the previous bit. Accordingly, for example, there may be no side information that a decoder may utilize to infer the next bit based on past observation (e.g., the previous bit(s)). Examples of control information fields that may have a relatively lower probability of repeating a same value over time or of not having bias to a value (a priori) may include (e.g., that have non-uniform probability distributions over potential codepoints) may include an RV, an NDI, a HARQ process number, or a downlink assignment index, among other examples.

In some aspects, control information (e.g., DCI, UCI, or SCI) fields that are sent at or towards the beginning of a control information format (e.g., DCI format or UCI format) may have relatively lower probabilities of being decoded successfully. Control information fields that are sent later in the control information format may have relatively higher probabilities of being decoded successfully.

In some examples of the techniques described herein, control information fields may be ordered in a control information format such that control information fields with relatively higher probabilities of having bias to a value or repeating a same value may be ordered at or towards the beginning of the control information format. For instance, control information fields at the beginning of a control information format may have a lower probability of successful decoding. Additionally, or alternatively, control information fields with relatively lower probabilities of having bias to a value or repeating a same value may be ordered later (e.g., towards the end) of the control information format. For instance, control information fields at the end of a control information format may have a higher probability of successful decoding. In some examples, the control information fields may follow a monotonically decreasing order of probability of bias or repetition. In some examples, the control information fields may follow a grouped (e.g., average or thresholded, among other examples) order of probability, where a group of control information fields at the beginning of a control information format generally have a higher probability of bias or repetition than a group of information fields at the end of the control information format (e.g., with or without a strict monotonically decreasing order of probability of bias or repetition).

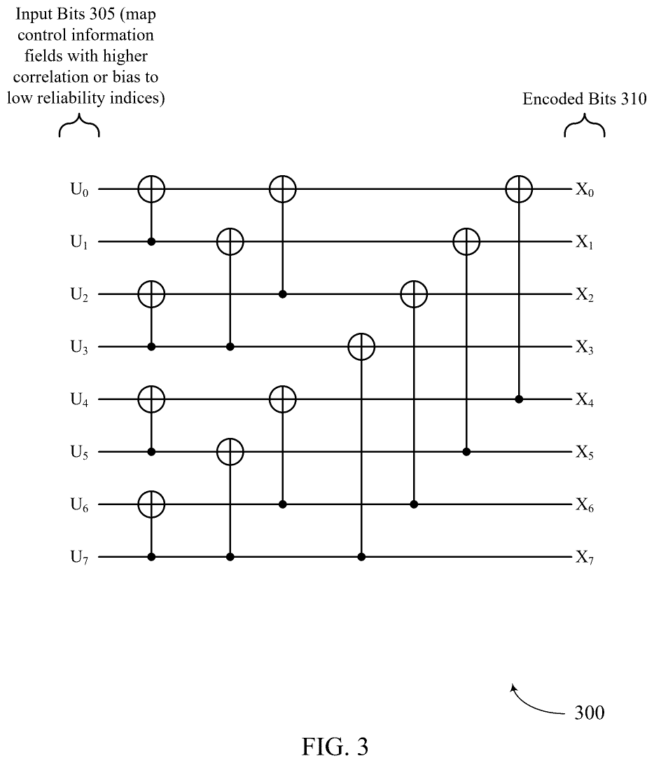

A polar code is a linear code (e.g., block error-correcting code) that utilizes channel polarization to improve reliability in the communication (e.g., decoding) of information. A polar code is structured to form synthetic channels (e.g., bit indices) that are polarized such that the synthetic channels have a range of reliabilities (e.g., probabilities of successful decoding). For instance, after a polar transform of the polar code, the synthetic channels may polarize to produce some more reliable synthetic channels and some less reliable synthetic channels. Each synthetic channel may have a corresponding reliability (e.g., probability of successful decoding). In some approaches, “frozen bits” (e.g., bits with a set value, such as 0) may be mapped to synthetic channels with relatively low reliability, and information bits (e.g., payload bits) may be mapped to synthetic channels with relatively high reliability. An example of a polar code structure is provided with reference to FIG. 3.

In some approaches, the synthetic channels (e.g., bit indices) of a polar code may be ordered in ascending or descending order of reliability. For instance, a polar sequence

$${Q}_{0}^{N - 1} = \{ {Q}_{0}^{N} , {Q}_{1}^{N} , … , {Q}_{N - 1}^{N} \}$$

may be defined, where

$$0 \leq {Q}_{i}^{N} \leq N - 1$$

may denote a bit index before polar encoding for i=0, 1, . . . , N−1 and N is a quantity of bits (e.g., N=1024). The polar sequence

$${Q}_{0}^{N - 1}$$

may be ordered in an ascending order of reliability

$$W ( {Q}_{0}^{N} ) < W ( {Q}_{1}^{N} ) < … < W ( {Q}_{N - 1}^{N} ) , where W ( {Q}_{i}^{N} )$$

denotes the reliability of the bit index Qᵢ^{N}. For instance, a reliability sequence of length 1024 may be defined for one or more devices (e.g., a UE 115-a or network entity 105-a), which may establish a reliability order of synthetic channels.

In an example, a descending order of reliability for a length—32 polar code may be: [32, 31, 30, 28, 24, 16, 29, 27, 26, 23, 22, 20, 15, 14, 12, 8, 25, 21, 19, 13, 18, 11, 10, 7, 6, 4, 17, 9, 5, 3, 2, 1], where each of the values corresponds to a synthetic channel or bit index. In this example, synthetic channels or bit indices 32, 31, 30, 28, 24, 16, 29, 27, 26, and 23 are the 10 most reliable channels of the polar code in descending order of reliability. For instance, bit index 32 may be more reliable than bit index 31, which may be more reliable than bit index 30, and so on.

An example of a scenario in which 10 information bits are transmitted over a length—32 polar code is provided as follows. After the bit indices are ordered in terms of reliability, a subset of the bit indices may be reordered in a natural order. In some approaches, control information (e.g., DCI, UCI, or SCI) may be arbitrarily mapped to the 10 most reliable synthetic channels of a polar code following the natural order (e.g., increasing index order) of the bit indices. For instance, when control information (e.g., DCI, UCI, or SCI) is mapped to the polar code, the control information fields a₁, a₂, . . . , a₁₀ may be mapped to synthetic channels 6, 23, 24, 26, 27, 28, 29, 30, 31, 32, which is a natural (e.g., increasing) ordering of the bit indices. The arbitrary mapping may provide adequate performance if each of the 10 information bits were equally likely to be 0 or 1. As described herein, however, some control information fields may have unequal probabilities of having a bias to a value or of being a same value over time. Accordingly, utilizing a natural (e.g., increasing) ordering for synthetic channel mapping may fail to achieve potential gains from mapping a bit with a higher probability of repeating the same value or having a bias to a value to a less reliable synthetic channel or bit index. For instance, if a first bit of DCI a₁ is likely to repeat or has a bias, then a₁ may be mapped to a less reliable (e.g., weakest) channel, such that the remaining 9 bits may occupy the top 9 most reliable (e.g., strongest) channels, which may improve (e.g., reduce) a block error rate (BLER) or bit error rate. Some approaches fail to achieve this improved mapping.

In some examples of the techniques described herein, control information fields may be mapped to synthetic channels (e.g., bit indices) of a polar code such that control information fields with relatively higher probabilities of having a value or repeating a same value may be mapped to synthetic channels with relatively lower reliability. For instance, control information fields with relatively higher probabilities of having a value or repeating a same value may be mapped to synthetic channels instead of frozen bits (e.g., bits with a set value, such as 0). Additionally, or alternatively, control information fields with relatively lower probabilities of having a biased value or repeating a same value may be mapped to synthetic channels with relatively higher reliability.

One or more of the polar code mapping or control information format ordering may be performed in accordance with the techniques described herein. In some approaches, the polar code mapping based on synthetic channel reliability and control information field probability may be performed independently from control information format ordering (e.g., with or without any particular control information format ordering). In some approaches, the control information format ordering may be performed independently from the polar code mapping (e.g., with or without any particular polar code mapping).

The UE 115-a or the network entity 105-a may communicate (e.g., output, send, transmit, obtain, or receive) a first control information field 240. The first control information field 240 may be ordered in a control information format (e.g., DCI format or UCI format) based on a first reliability of a first bit index of a polar code associated with the first control information field 240. For example, the first control information field 240 may be associated with the first bit index of the polar code with the first reliability and may be ordered in the control information format (in a slot, for instance).

The UE 115-a or the network entity 105-a may communicate (e.g., output, send, transmit, obtain, or receive) a second control information field 245 with the network entity 105-a. The second control information field 245 may be ordered in the control information format based on a second reliability of a second bit index of the polar code associated with the second control information field 245. For example, the second control information field 245 may be associated with the second bit index of the polar code with the second reliability and may be ordered in the control information format (in the slot, for instance).

The first bit index and the second bit index may be included in a set of indices of the polar code that is ordered in an ascending or descending order of reliability. For instance, the set of indices may be ordered to be monotonically increasing or monotonically decreasing in reliability. In some examples, the set of indices may be ordered in terms of reliability, where the indices themselves may not be ordered in a natural (e.g., continuously increasing or decreasing order). For instance, the set of indices [32, 31, 30, 28, 24, 16, 29, 27, 26, 23] may be ordered in a monotonically decreasing order of reliability, where the indices do not monotonically decrease over the whole set.

In some examples, the set of indices may correspond to all bits (e.g., N bits) of a polar code, or may correspond to a subset of all bits (e.g., less than N bits) of a polar code. For instance, a polar code with 32 bits (e.g., N=32) may be sorted in decreasing order of reliability as [32, 31, 30, 28, 24, 16, 29, 27, 26, 23, 22, 20, 15, 14, 12, 8, 25, 21, 19, 13, 18, 11, 10, 7, 6, 4, 17, 9, 5, 3, 2, 1], where the set of indices may correspond to the first 10 (e.g., most reliable) bit indices [32, 31, 30, 28, 24, 16, 29, 27, 26, 23]. In another example, a polar code with 32 bits may be sorted in increasing order of reliability as [1, 2, 3, 5, 9, 17, 4, 6, 7, 10, 11, 18, 13, 19, 21, 25, 8, 12, 14, 15, 20, 22, 23, 26, 27, 29, 16, 24, 28, 30, 31, 32], and the set of indices may correspond to the last (e.g., most reliable) bit indices [23, 26, 27, 29, 16, 24, 28, 30, 31, 32]. In some aspects of the techniques described herein, the bit indices or set of indices may be sorted in ascending or descending order of reliability (e.g., over the whole set of indices), and may not be reordered in natural order of the indices.

In some approaches, the control information fields may be ordered based on the reliabilities of the associated bit indices of the polar code. In some examples, the term “order” (or variations thereof) of the control information fields may refer to an order in which the control information fields are mapped to bit indices of a polar code, to an order in which the control information fields are placed in a control information format, or a combination thereof. In some aspects, the ordering may indicate where to map each of the control fields (e.g., bits of the control fields) in the polar code based on the corresponding reliability of the polar synthesized channels. In some approaches, the control information fields may be mapped to the bit indices of the polar code based on the reliabilities of the bit indices. For example, a first field in DCI (e.g., a DCI format) may be mapped to a least reliable channel, a second field in DCI may be mapped to a next least reliable channel, and so on.

Additionally, or alternatively, the control information fields may be ordered in a control information format in association with (e.g., based on) the reliabilities of the bit indices. For example, the first control information field that is ordered at the beginning of the control information format may be mapped to a bit index with a lowest reliability in the set of bit indices. For instance, the first control information field that may be mapped to a bit index with a lowest reliability in the set of bit indices (or in a subset of the set of bit indices) may be ordered at the beginning of the control information format. In some examples, the first control information field (that is mapped to a bit index with a lowest reliability and is ordered first at the beginning of the control information format) may have a highest probability (of the control information fields in the control information format) of repeating a same value or having a highest bias to a value. A next (e.g., second) control information field that is ordered second from the beginning of the control information format may be mapped to a bit index with a second lowest reliability in the set of bit indices. For instance, a next (e.g., the second) control information field that may be mapped to a bit index with a next lowest reliability in the set of bit indices (or in a subset of the set of bit indices) may ordered next after the first control information field in the control information format. In some examples, the next (e.g., second) control information field (that is mapped to a bit index with a next lowest reliability and is ordered next after the first control information field) may have a next highest probability (of the control information fields in the control information format) of repeating a same value or having a highest bias to a value.

In some examples, the first reliability of the first bit index may be less than the second reliability of the second bit index. The first control information field 240 may indicate a control information (e.g., DCI, UCI, or SCI) format indicator, an MCS, a TDRA, an FDRA, a TPC value, HARQ (e.g., HARQ-ACK) timing information, a PUCCH resource indicator, an SRS request, an antenna port indicator, or a DMRS sequence indicator. The second control information field 245 may indicate an RV, an NDI, a HARQ process number, or a downlink assignment index. For instance, the first control information field 240 may be less likely to vary than the second control information field 245. The first control information field 240 may accordingly be ordered before the second control information field 245 in the control information format, or may be mapped to a less reliable bit index of the polar code than a bit index to which the second control information field 245 is mapped.

In some approaches, two or more of the control information fields may be ordered in the control information format in an increasing order of associated bit index reliability or in a decreasing order of time correlation or bias to a value. In some aspects, the control information field (e.g., DCI field or UCI field) ordering may be established (e.g., hardcoded, previously set) in the UE 115-a or the network entity 105-a.

In some approaches, the network entity 105-a or the UE 115-a may communicate (e.g., output, send, transmit, obtain, or receive) a configuration (e.g., configuration information, RRC signaling, or medium access control-control element (MAC-CE) signaling, among other examples). The configuration may indicate an ordering of the first control information field 240 and the second control information field 245 in the control information format. For instance, the network entity 105-a may indicate a configuration for control information field ordering for DCI, UCI, or SCI.

In some scenarios, the correlation or statistical models of the control information fields may depend on (e.g., vary based on) network implementation or scheduling procedures, among other examples. For instance, different observations in terms of control information field correlations or probability models may occur between different networks or different scheduling approaches. Instead of having a fixed control information (e.g., DCI, UCI, or SCI) field ordering (e.g., a hardcoded or previously set ordering), the network entity 105-a may configure the control information field ordering for one or more (e.g., each) control information format to the UE 115-a. For instance, the network entity 105-a may send configuration information indicating an ordering of control information fields in a control information format or slot.

In some examples, the configuration may indicate a probability model associated with the first control information field 240. The probability model may indicate a probability for each respective bit of the first control information field 240 to have a value. Additionally, or alternatively, the probability model may indicate a conditional probability that the first control information field 240 has a same value as a previous first control information field (e.g., a previous first control information field communicated in a slot previous to a slot in which the first control information field 240 is communicated). For instance, the network entity 105-a may indicate (to the UE 115-a) the probability models of the control information fields, such as a probability of each codepoint of a field or a conditional probability of reusing the same value for two consecutive transmissions, among other examples.

In some approaches, the network entity 105-a may determine the probability model based on values of previous control information fields. For instance, the network entity 105-a may collect statistical information corresponding to values of one or more control information fields (e.g., the first control information field 240 or the second control information field 245), and may determine one or more probability models (e.g., probability distribution(s), density function(s), mean, standard deviation, or variance, among other examples) corresponding to control information fields. In some aspects, the network entity 105-a may send a configuration to the UE 115-a to indicate a change in ordering of the control information fields based on observed changes in probability models of the control information fields over time.

The ordering of control information fields may vary between different networks or different network entities in some aspects. For example, the ordering of the first control information field 240 and the second control information field 245 may differ from a previous ordering of a previous first control information field and a previous second control information field indicated by a previous configuration. In some cases, the previous configuration may be received from another network entity (not shown in FIG. 2) that is different from the network entity 105-a from which the configuration is received.

In some examples, the configuration may indicate one or more mappings of one or more control information fields (e.g., the first control information field 240 or the second control information field 245) to one or more bit indices or synthetic channels of the polar code. As described herein correlations or statistical models of the control information fields may depend on (e.g., vary based on) network implementation or scheduling procedures, among other examples. Instead of having a fixed polar code mapping, the network entity 105-a may configure the polar code mapping for one or more control information fields. For instance, the network entity 105-a may send configuration information indicating one or more mappings of control information fields to bit indices of a polar code. In some approaches, the mapping(s) may be configured based on one or more probability models, which may be determined or indicated by the network entity 105-a as described herein. In some approaches, the UE 115-a may determine or indicate one or more probability models based on observed values of one or more control information field. In some examples, the UE 115-a or the network entity 105-a may communicate a request to change the control information field ordering or polar code mapping based on the probability model(s).

The mapping of control information fields to bit indices may vary between different networks or different network entities in some aspects. For example, the mapping of the first control information field 240 and the second control information field 245 may differ from a previous mapping of a previous first control information field and a previous second control information field indicated by a previous configuration.

In some examples, the UE 115-a (e.g., first formatting component 255) or the network entity 105-a (e.g., second formatting component 260) may map the first control information field 240 to the first bit index, or may map the second control information field 245 to the second bit index. For instance, the first control information field 240 may be ordered before the second control information field 245 in the control information format, or the first reliability of the first bit index may be less than the second reliability of the second bit index. In an example, the first control information field 240 or the second control information field 245 may be communicated after mapping. For instance, the UE 115-a may perform mapping for UCI and transmit the UCI to the network entity 105-a for de-mapping. In another example, the network entity 105-a may perform mapping for DCI and transmit the DCI to the UE 115-a for de-mapping.

In some examples, the UE 115-a (e.g., first formatting component 255) or the network entity 105-a (e.g., second formatting component 260) may de-map the first control information field 240 from the first bit index, or may de-map the second control information field 245 from the second bit index. For instance, the first control information field 240 may be ordered before the second control information field 245 in the control information format, or the first reliability of the first bit index may be less than the second reliability of the second bit index. In an example, the first control information field 240 or the second control information field 245 may be de-mapped after communication. For instance, the UE 115-a may perform de-mapping for DCI after receiving the DCI from the network entity 105-a. In another example, the network entity 105-a may perform de-mapping for UCI after receiving the UCI from the UE 115-a.

In some examples, a control information field (e.g., the first control information field 240 or the second control information field 245) may include multiple bits. The UE 115-a (e.g., first formatting component 255) or the network entity 105-a (e.g., second formatting component 260) may map each respective bit of the multiple bits to respective indices of a subset of the set of indices, where the respective indices of the subset of the set of indices may be associated with consecutive reliabilities in the ascending or descending order of reliability. For instance, in a case that a control information field includes more than 1 bit (e.g., a two-bit field), such as M bits, the M bits of the control information field may be mapped to respective M bit indices (e.g., M synthetic channel indices) associated with consecutive channel reliabilities in the order of reliability.

In some approaches, each respective bit of the multiple bits may be mapped in an order of the consecutive reliabilities or in an order of the subset of the set of indices. In some aspects, the UE 115-a (first formatting component 255) or the network entity 105-a (e.g., second formatting component 260) may order the M channel indices according to a natural order of the set of indices, or according to the reliabilities of the M bit indices. For instance, to map a 3-bit control field to polar code bit indices 17, 23, and 19 (ordered according to reliability), the three bits may be mapped to the bit indices 17, 23, and 19 according to the reliability order, or may be mapped to 17, 19, and 23 according to the natural order of the set of indices.

In some examples, a control information field (e.g., the first control information field 240 or the second control information field 245) may include multiple bits. The UE 115-a (e.g., first formatting component 255) or the network entity 105-a (e.g., second formatting component 260) may de-map each respective bit of the multiple bits from respective indices of a subset of the set of indices, where the respective indices of the subset of the set of indices may be associated with consecutive reliabilities in the ascending or descending order of reliability. For instance, in a case that a control information field includes more than 1 bit (e.g., a two-bit field), such as M bits, the M bits of the control information field may be de-mapped from respective M bit indices (e.g., M synthetic channel indices) associated with consecutive channel reliabilities in the order of reliability.

In some examples, the UE 115-a or the network entity 105-a may communicate an indication of a capability of the UE 115-a to utilize the polar code that is ordered in an ascending or descending order of reliability. For instance, the UE 115-a may send capability signaling to the network entity 105-a indicating that the UE 115-a is capable of utilizing the polar code in accordance with one or more techniques described herein. Communicating the first control information field 240 or communicating the second control information field 245 may be performed based on the capability of the UE 115-a.

FIG. 3 shows an example of a signal flow diagram 300 that supports control information associations for polar codes in accordance with one or more aspects of the present disclosure. The signal flow diagram 300 illustrates an example of a polar code structure. For example, the signal flow diagram 300 illustrates a polar code structure with 8 input bits 305 (U₀, U₁, U₂, U₃, U₄, U₅, U₆, and U₇), and 8 encoded bits 310 (X₀, X₁, X₂, X₃, X₄, X₅, X₆, and X₇).

For polar code design, the reliability order among the bit indices or the synthetic channels may be identified. Information bits may be mapped to the bit indices or channels with higher reliability. In the example of FIG. 3, some of the input bits 305 may correspond to synthetic channels or bit indices with lower reliability (e.g., frozen bits) U₀, U₁, U₂, and U₄, while some of the input bits 305 may correspond to synthetic channels or bit indices with higher reliability U₃, U₅, U₆, and U₇. In accordance with some of the techniques described herein, control information fields with higher correlation (e.g., time correlation) or bias (e.g., bias to a value) may be mapped to the bit indices 0, 1, 2, and 4 with lower reliability (e.g., U₀, U₁, U₂, and U₄). Control information fields with lower correlation or bias may be mapped to bit indices 3, 5, 6, and 7 with higher reliability (e.g., U₃, U₅, U₆, and U₇). The mapping may be performed such that the control information fields ordered from highest time correlation or bias to lowest time correlation or bias may be respectively mapped to bit indices ordered from lowest reliability to highest reliability.

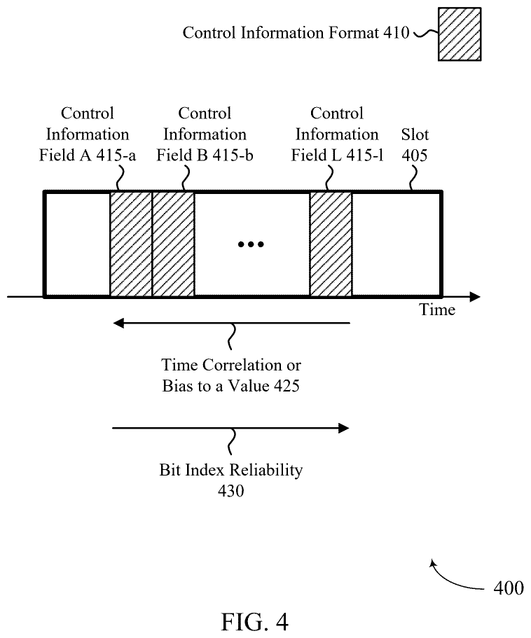

FIG. 4 shows an example of a timing diagram 400 that supports control information associations for polar codes in accordance with one or more aspects of the present disclosure. The timing diagram 400 illustrates an example of a slot 405 that may be utilized for communications between a UE (e.g., the UE 115-a described with reference to FIG. 2) and a network entity (e.g., the network entity 105-a described with reference to FIG. 2). A control information format 410 (e.g., control information fields) may be communicated (e.g., transmitted or received) in the slot 405. As illustrated in the example of FIG. 4, the control information format 410 may include control information field A 415-a and control information field B 415-b to control information field L 415-1. Each of the control information fields may include or represent one or more bits of control information. One or more of control information field A 415-a and control information field B 415-b to control information field L 415-1 may be examples of the first control information field 240 or the second control information field 245 described with reference to FIG. 2. For instance, control information field A 415-a may be an example of the first control information field 240 and control information field B 415-b may be an example of the second control information field 245 described with reference to FIG. 1.

In some examples of the techniques described herein, one or more control information fields that exhibit a higher time correlation or bias to a value 425 may be placed at the beginning of the control information format 410. For instance, control information field A 415-a may have a higher time correlation or bias to a value 425 than control information field B 415-b, which may have a higher time correlation or bias to a value 425 than control information field L 415-1. Accordingly, control information field A 415-a may be communicated first in the control information format 410, followed by control information field B 415-b, and so on, to control information field L 415-1.

In some examples of the techniques described herein, one or more control information fields may be mapped based on an ascending or descending order of bit index reliability 430 of polar code bit indices. The mapping based on the order of bit index reliability 430 may be performed in addition to, or alternatively from, the control information field ordering in the control information format 410. In some approaches, control information fields that exhibit a higher time correlation or bias to a value 425 may be mapped to one or more bit indices with lower reliability. For instance, control information field A 415-a may have a higher time correlation or bias to a value 425 than control information field B 415-b, which may have a higher time correlation or bias to a value 425 than control information field L 415-1. Accordingly, control information field A 415-a may be mapped to one or more bits with lower bit index reliability, followed by control information field B 415-b that may be mapped to one or more bits with greater bit index reliability (than the bit index or indices for control information field A 415-a), and so on, to control information field L 415-1 that may be mapped to one or more bits with greater bit index reliability (than the bit index or indices for control information field A 415-a and control information field B 415-b). The mapping based on the order of bit index reliability 430 or the control information field ordering in the control information format 410 may achieve improved BLER performance.

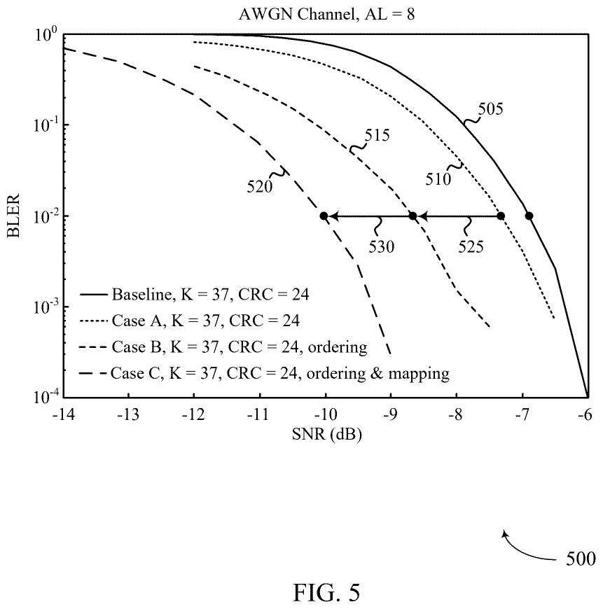

FIG. 5 shows an example of a graph 500 that supports control information associations for polar codes in accordance with one or more aspects of the present disclosure. The graph 500 illustrates plots of BLERs over SNR for decoding various cases of encoded bits with CRC communicated via an additive white Gaussian noise (AWGN) channel with an aggregation level (AL) of 8. For instance, a baseline case 505, case A 510, case B 515, and case C 520 are illustrated. In the baseline case, K=37 bit indices are utilized with CRC=24 bits in a polar encoder. In case A 510, K=37 bit indices are utilized with CRC=24 bits in a polar encoder, where the last 31 bits have values with a relatively high likelihood of being correlated over time or biased to respective values.

In case B 515, K=37 bit indices are utilized with CRC=24 bits in a polar encoder, where the first 31 bits have values with a relatively high likelihood of being correlated over time or biased to respective values. In case B 515, for instance, the control information fields with values that are relatively strongly correlated in time or that are biased to values are be ordered or placed at or near the beginning of the control information format. Approximately 1.5 dB of gain 525 in SNR may be achieved by moving these bits to the beginning of the control information format.

In case C 520, K=37 bit indices are utilized with CRC=24 bits in a polar encoder, where the bits that have values with a relatively low likelihood of being correlated over time or biased to respective values are mapped to more reliable bit indices. In case C 520, for instance, control information bits a₁, a₂, . . . , a_{K} (including CRC bits, for instance) may be mapped to the polar code following a reliability order of the bit indices. For instance, the first bit of control information (e.g., UCI or DCI) may be mapped to the synthetic channel with least reliability (among the top K reliable synthetic channels of a polar code), and the last bit of control information may be mapped to the synthetic channel with the highest reliability. Mapping the control information fields to the bit indices in this manner may achieve another approximate 1.5 dB gain 530 in SNR via the mapping. For instance, a performance gain of more than 2.5 dB may be achieved when the ordering and mapping are utilized in combination. One or more of the control information field arranging or polar code mapping approaches may be utilized alone or in combination in accordance with some examples of the techniques described herein.

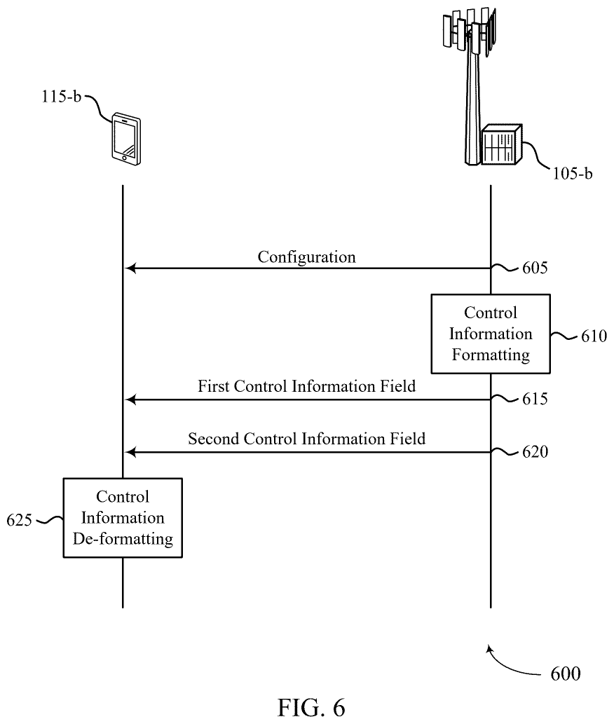

FIG. 6 shows an example of a process flow 600 that supports control information associations for polar codes in accordance with one or more aspects of the present disclosure. In some examples, aspects of the process flow 600 may implement or be implemented by aspects of the wireless communications system 100 or the wireless communications system 200. For example, the process flow 600 may be implemented by a UE 115-b or a network entity 105-b, which may be examples of the corresponding devices as described herein with reference to FIGS. 1 and 2. In the following description of the process flow 600, the operations between the network entity 105-b and the UE 115-b may be performed in a different order than the example order shown in some examples. In some approaches, one or more operations may be omitted from the process flow 600 or added to the process flow 600. Further, although some operations or signaling may be shown to occur at different times for discussion purposes, these operations may actually occur at the same time in some examples.

At 605, the network entity 105-b may output, or the UE 115-b may receive, a configuration. For instance, the configuration may be communicated as described with reference to FIG. 2 (e.g., via RRC or MAC-CE signaling, among other examples). In some examples, the configuration may indicate an ordering of a first control information field and a second control information field, or may indicate a mapping of a first control information field and a second control information field to bit indices of a polar code.

At 610, the network entity 105-b may perform control information formatting. For instance, the network entity 105-b may format one or more control information fields or bits as described with reference to FIG. 2. In some examples, the network entity 105-b may order (e.g., arrange) control information fields in a control information format such that one or more control information fields with relatively higher time correlations or biases to values may be arranged at (e.g., from) the beginning of the control information format. Additionally, or alternatively, the network entity 105-b may map control information fields to bit indices of a polar code such that one or more control information fields with relatively higher time correlations or biases to values may be mapped to bit indices with relatively lower reliability.

At 615, the network entity 105-b may output, or the UE 115-b may receive, a first control information field. For instance, the first control information field may be communicated as described with reference to FIG. 2.

At 620, the network entity 105-b may output, or the UE 115-b may receive, a second control information field. For instance, the second control information field may be communicated as described with reference to FIG. 2.

At 625, the UE 115-b may perform control information de-formatting. For instance, the UE 115-b may de-format the first control information field and the second control information field as described with reference to FIG. 2. In some examples, the UE 115-b may obtain (e.g., extract) the first control information field and the second control information field based on (e.g., in accordance with) the ordering of the control information fields indicated by the configuration. Additionally, or alternatively, the UE 115-b may de-map the first control information field and the second control information field from bit indices of a polar code based on (e.g., in accordance with) the mapping indicated by the configuration.

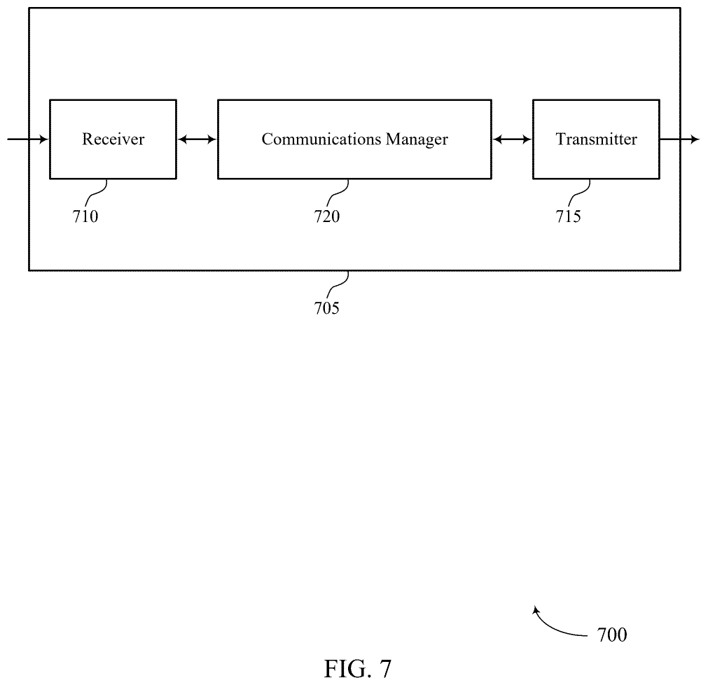

FIG. 7 shows a block diagram 700 of a device 705 that supports control information associations for polar codes in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to control information associations for polar codes). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to control information associations for polar codes). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of control information associations for polar codes as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

For example, the communications manager 720 is capable of, configured to, or operable to support a means for communicating a first control information field with a network entity, where the first control information field is ordered in a control information format based on a first reliability of a first bit index of a polar code associated with the first control information field. The communications manager 720 is capable of, configured to, or operable to support a means for communicating a second control information field with the network entity, where the second control information field is ordered in the control information format based on a second reliability of a second bit index of the polar code associated with the second control information field, and where the first bit index and the second bit index are included in a set of multiple indices of the polar code that is ordered in an ascending or descending order of reliability.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing, reduced power consumption, or more efficient utilization of communication resources.

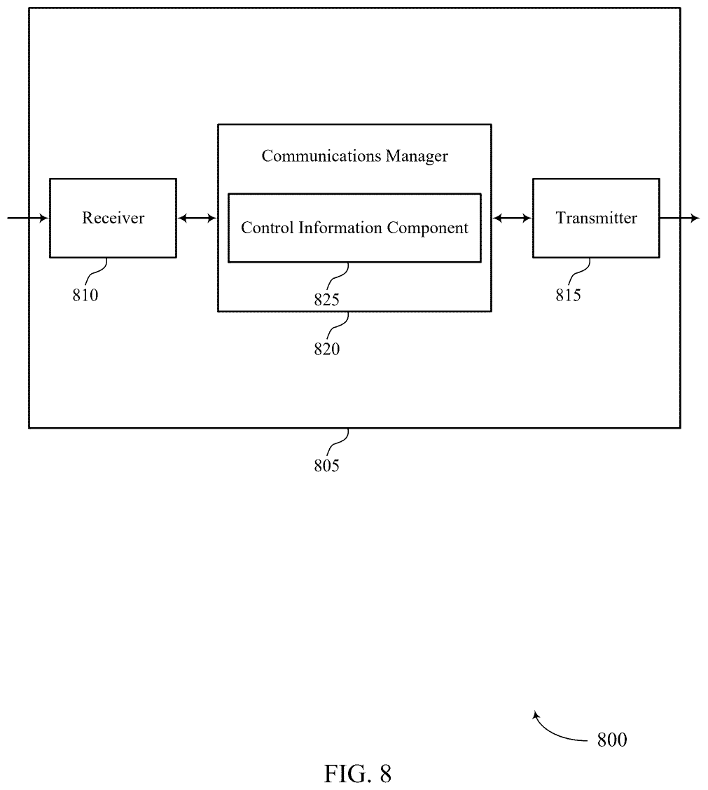

FIG. 8 shows a block diagram 800 of a device 805 that supports control information associations for polar codes in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to control information associations for polar codes). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to control information associations for polar codes). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of control information associations for polar codes as described herein. For example, the communications manager 820 may include a control information component 825. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The control information component 825 is capable of, configured to, or operable to support a means for communicating a first control information field with a network entity, where the first control information field is ordered in a control information format based on a first reliability of a first bit index of a polar code associated with the first control information field. The control information component 825 is capable of, configured to, or operable to support a means for communicating a second control information field with the network entity, where the second control information field is ordered in the control information format based on a second reliability of a second bit index of the polar code associated with the second control information field, and where the first bit index and the second bit index are included in a set of multiple indices of the polar code that is ordered in an ascending or descending order of reliability.

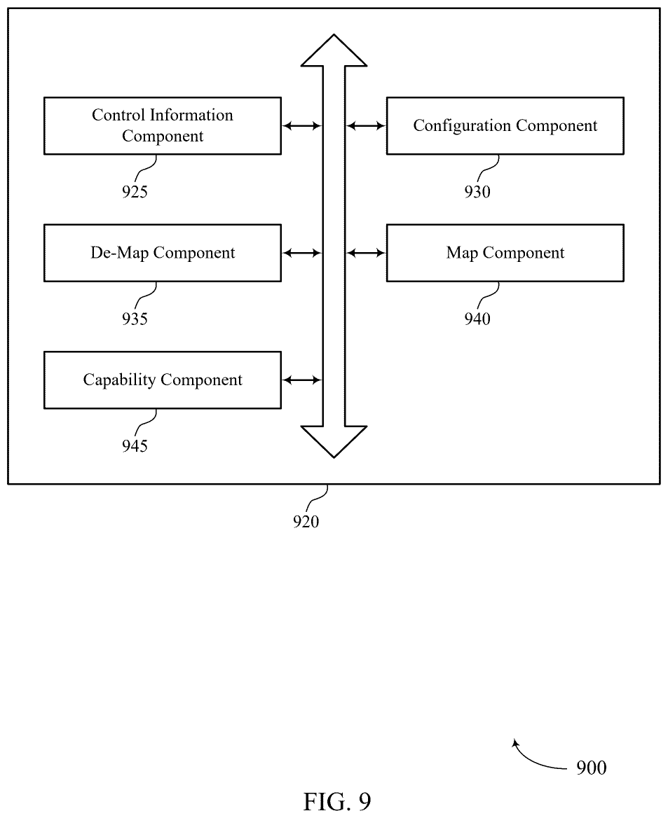

FIG. 9 shows a block diagram 900 of a communications manager 920 that supports control information associations for polar codes in accordance with one or more aspects of the present disclosure. The communications manager 920 may be an example of aspects of a communications manager 720, a communications manager 820, or both, as described herein. In some examples, the communications manager 920 may include the first formatting component 255 described with reference to FIG. 1, or the communications manager 920 may perform one or more of the operations of the UE 115-a described with reference to FIG. 1. The communications manager 920, or various components thereof, may be an example of means for performing various aspects of control information associations for polar codes as described herein. For example, the communications manager 920 may include a control information component 925, a configuration component 930, a de-map component 935, a map component 940, a capability component 945, or any combination thereof. Each of these components, or components or subcomponents thereof (e.g., one or more processors, one or more memories), may communicate, directly or indirectly, with one another (e.g., via one or more buses).

The control information component 925 is capable of, configured to, or operable to support a means for communicating a first control information field with a network entity, where the first control information field is ordered in a control information format based on a first reliability of a first bit index of a polar code associated with the first control information field. In some examples, the control information component 925 is capable of, configured to, or operable to support a means for communicating a second control information field with the network entity, where the second control information field is ordered in the control information format based on a second reliability of a second bit index of the polar code associated with the second control information field, and where the first bit index and the second bit index are included in a set of multiple indices of the polar code that is ordered in an ascending or descending order of reliability.

In some examples, the configuration component 930 is capable of, configured to, or operable to support a means for receiving a configuration from the network entity, where the configuration indicates an ordering of the first control information field and the second control information field in the control information format.

In some examples, the configuration indicates a probability model associated with the first control information field, the probability model indicating a probability for each respective bit of the first control information field to have a value, or a conditional probability that the first control information field has a same value as a previous first control information field.

In some examples, the ordering of the first control information field and the second control information field differs from a previous ordering of a previous first control information field and a previous second control information field indicated by a previous configuration.

In some examples, the previous configuration is received from another network entity that is different from the network entity from which the configuration is received.

In some examples, the first reliability of the first bit index is less than the second reliability of the second bit index, the first control information field indicates a control information format indicator, a MCS, a TDRA, a FDRA, a TPC) value, HARQ timing information, a PUCCH resource indicator, an SRS request, an antenna port indicator, or a DMRS sequence indicator, and the second control information field indicates a RV, NDI, a HARQ process number, or a downlink assignment index.

In some examples, the de-map component 935 is capable of, configured to, or operable to support a means for de-mapping the first control information field from the first bit index. In some examples, the de-map component 935 is capable of, configured to, or operable to support a means for de-mapping the second control information field from the second bit index, where the first control information field is ordered before the second control information field in the control information format, and the first reliability of the first bit index is less than the second reliability of the second bit index.

In some examples, the map component 940 is capable of, configured to, or operable to support a means for mapping the first control information field to the first bit index. In some examples, the map component 940 is capable of, configured to, or operable to support a means for mapping the second control information field to the second bit index, where the first control information field is ordered before the second control information field in the control information format, and the first reliability of the first bit index is less than the second reliability of the second bit index.

In some examples, the first control information field includes a set of multiple bits, and the de-map component 935 is capable of, configured to, or operable to support a means for de-mapping each respective bit of the set of multiple bits from respective indices of a subset of the set of multiple indices, where the respective indices of the subset of the set of multiple indices are associated with consecutive reliabilities in the ascending or descending order of reliability.

In some examples, the first control information field includes a set of multiple bits, and the map component 940 is capable of, configured to, or operable to support a means for mapping each respective bit of the set of multiple bits to respective indices of a subset of the set of multiple indices, where the respective indices of the subset of the set of multiple indices are associated with consecutive reliabilities in the ascending or descending order of reliability.

In some examples, each respective bit of the set of multiple bits is mapped in an order of the consecutive reliabilities or in an order of the subset of the set of multiple indices.

In some examples, the capability component 945 is capable of, configured to, or operable to support a means for sending an indication of a capability of the UE to utilize the polar code that is ordered in an ascending or descending order of reliability, where communicating the first control information field and communicating the second control information field are performed based on the capability of the UE.

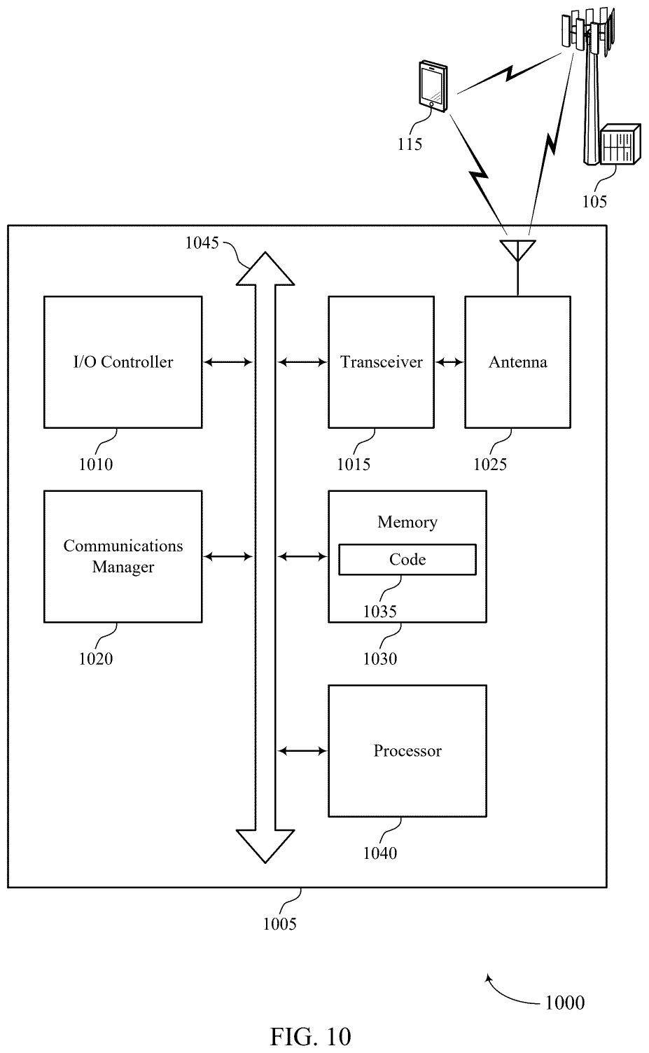

FIG. 10 shows a diagram of a system 1000 including a device 1005 that supports control information associations for polar codes in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting control information associations for polar codes). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

For example, the communications manager 1020 is capable of, configured to, or operable to support a means for communicating a first control information field with a network entity, where the first control information field is ordered in a control information format based on a first reliability of a first bit index of a polar code associated with the first control information field. The communications manager 1020 is capable of, configured to, or operable to support a means for communicating a second control information field with the network entity, where the second control information field is ordered in the control information format based on a second reliability of a second bit index of the polar code associated with the second control information field, and where the first bit index and the second bit index are included in a set of multiple indices of the polar code that is ordered in an ascending or descending order of reliability.

By including or configuring the communications manager 1020 in accordance with examples as described herein, the device 1005 may support techniques for improved communication reliability, reduced latency, improved user experience related to reduced processing, reduced power consumption, more efficient utilization of communication resources, improved coordination between devices, longer battery life, or improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of control information associations for polar codes as described herein, or the at least one processor 1040 and the at least one memory 1030 may be otherwise configured to, individually or collectively, perform or support such operations.

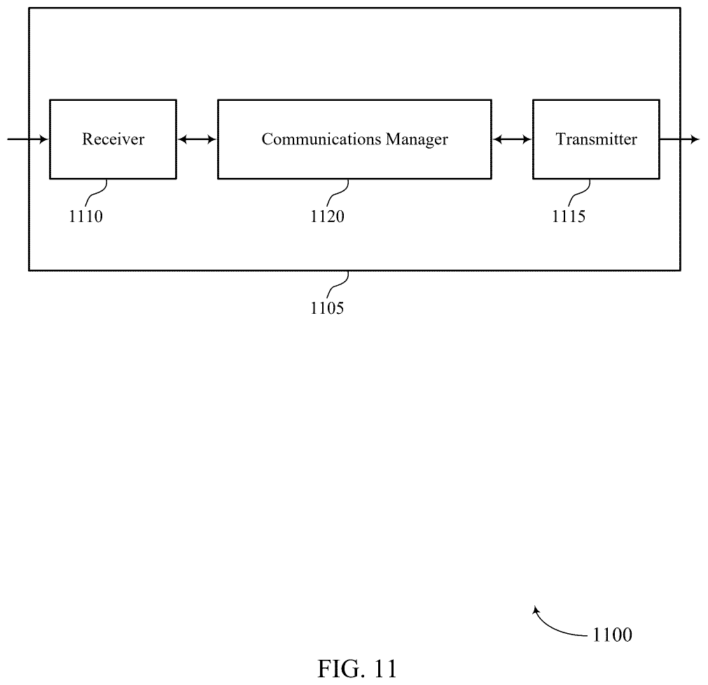

FIG. 11 shows a block diagram 1100 of a device 1105 that supports control information associations for polar codes in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of control information associations for polar codes as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

For example, the communications manager 1120 is capable of, configured to, or operable to support a means for communicating a first control information field with a UE, where the first control information field is ordered in a control information format based on a first reliability of a first bit index of a polar code associated with the first control information field. The communications manager 1120 is capable of, configured to, or operable to support a means for communicating a second control information field with the UE, where the second control information field is ordered in the control information format based on a second reliability of a second bit index of the polar code associated with the second control information field, and where the first bit index and the second bit index are included in a set of multiple indices of the polar code that is ordered in an ascending or descending order of reliability.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reduced processing, reduced power consumption, or more efficient utilization of communication resources.

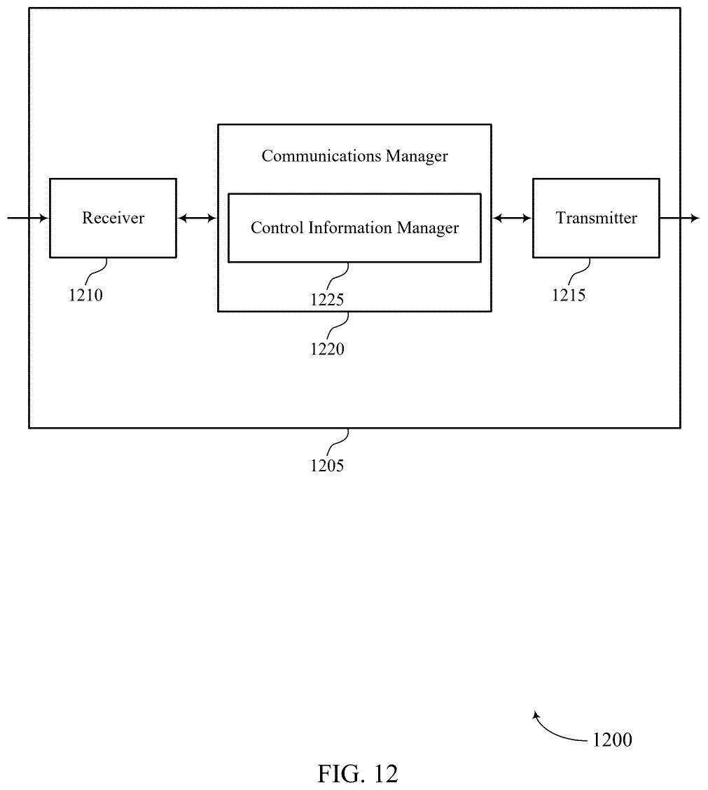

FIG. 12 shows a block diagram 1200 of a device 1205 that supports control information associations for polar codes in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of control information associations for polar codes as described herein. For example, the communications manager 1220 may include a control information manager 1225. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The control information manager 1225 is capable of, configured to, or operable to support a means for communicating a first control information field with a UE, where the first control information field is ordered in a control information format based on a first reliability of a first bit index of a polar code associated with the first control information field. The control information manager 1225 is capable of, configured to, or operable to support a means for communicating a second control information field with the UE, where the second control information field is ordered in the control information format based on a second reliability of a second bit index of the polar code associated with the second control information field, and where the first bit index and the second bit index are included in a set of multiple indices of the polar code that is ordered in an ascending or descending order of reliability.

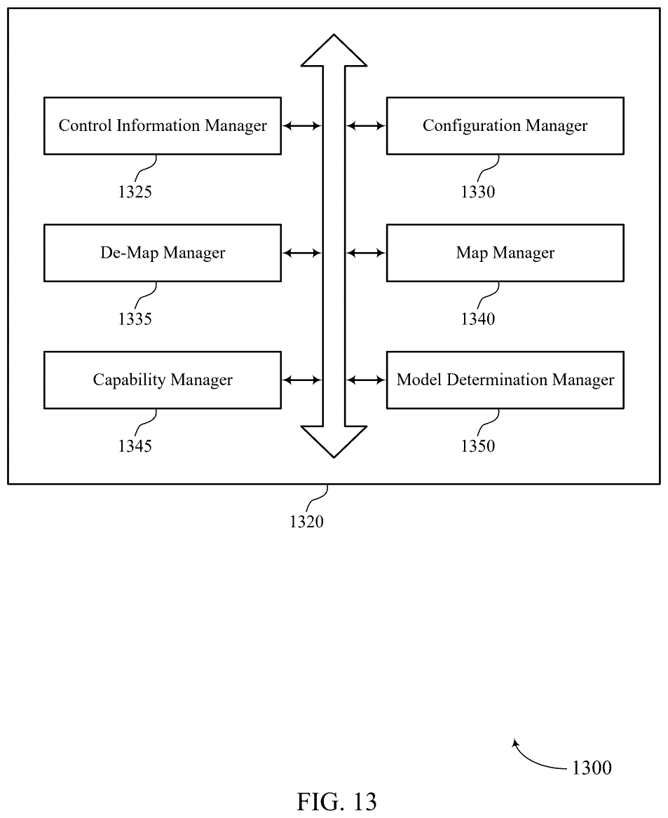

FIG. 13 shows a block diagram 1300 of a communications manager 1320 that supports control information associations for polar codes in accordance with one or more aspects of the present disclosure. The communications manager 1320 may be an example of aspects of a communications manager 1120, a communications manager 1220, or both, as described herein. In some examples, the communications manager 1320 may include the second formatting component 260 described with reference to FIG. 1, or the communications manager 1320 may perform one or more of the operations of the network entity 105-a described with reference to FIG. 1. The communications manager 1320, or various components thereof, may be an example of means for performing various aspects of control information associations for polar codes as described herein. For example, the communications manager 1320 may include a control information manager 1325, a configuration manager 1330, a de-map manager 1335, a map manager 1340, a capability manager 1345, a model determination manager 1350, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The control information manager 1325 is capable of, configured to, or operable to support a means for communicating a first control information field with a UE, where the first control information field is ordered in a control information format based on a first reliability of a first bit index of a polar code associated with the first control information field. In some examples, the control information manager 1325 is capable of, configured to, or operable to support a means for communicating a second control information field with the UE, where the second control information field is ordered in the control information format based on a second reliability of a second bit index of the polar code associated with the second control information field, and where the first bit index and the second bit index are included in a set of multiple indices of the polar code that is ordered in an ascending or descending order of reliability.

In some examples, the configuration manager 1330 is capable of, configured to, or operable to support a means for sending a configuration to the UE, where the configuration indicates an ordering of the first control information field and the second control information field in the control information format.

In some examples, the configuration indicates a probability model associated with the first control information field, the probability model indicating a probability for each respective bit of the first control information field to have a value, or a conditional probability that the first control information field has a same value as a previous first control information field.

In some examples, the model determination manager 1350 is capable of, configured to, or operable to support a means for determining the probability model based on a set of multiple values of previous first control information fields.

In some examples, the ordering of the first control information field and the second control information field differs from a previous ordering of a previous first control information field and a previous second control information field indicated by a previous configuration.

In some examples, the de-map manager 1335 is capable of, configured to, or operable to support a means for de-mapping the first control information field from the first bit index. In some examples, the de-map manager 1335 is capable of, configured to, or operable to support a means for de-mapping the second control information field from the second bit index, where the first control information field is ordered before the second control information field in the control information format, and the first reliability of the first bit index is less than the second reliability of the second bit index.

In some examples, the map manager 1340 is capable of, configured to, or operable to support a means for mapping the first control information field to the first bit index. In some examples, the map manager 1340 is capable of, configured to, or operable to support a means for mapping the second control information field to the second bit index, where the first control information field is ordered before the second control information field in the control information format, and the first reliability of the first bit index is less than the second reliability of the second bit index.

In some examples, the first control information field includes a set of multiple bits, and the de-map manager 1335 is capable of, configured to, or operable to support a means for de-mapping each respective bit of the set of multiple bits from respective indices of a subset of the set of multiple indices, where the respective indices of the subset of the set of multiple indices are associated with consecutive reliabilities in the ascending or descending order of reliability.

In some examples, the first control information field includes a set of multiple bits, and the map manager 1340 is capable of, configured to, or operable to support a means for mapping each respective bit of the set of multiple bits to respective indices of a subset of the set of multiple indices, where the respective indices of the subset of the set of multiple indices are associated with consecutive reliabilities in the ascending or descending order of reliability.

In some examples, each respective bit of the set of multiple bits is mapped in an order of the consecutive reliabilities or in an order of the subset of the set of multiple indices.

In some examples, the capability manager 1345 is capable of, configured to, or operable to support a means for receiving an indication of a capability of the UE to utilize the polar code that is ordered in an ascending or descending order of reliability, where communicating the first control information field and communicating the second control information field are performed based on the capability of the UE.

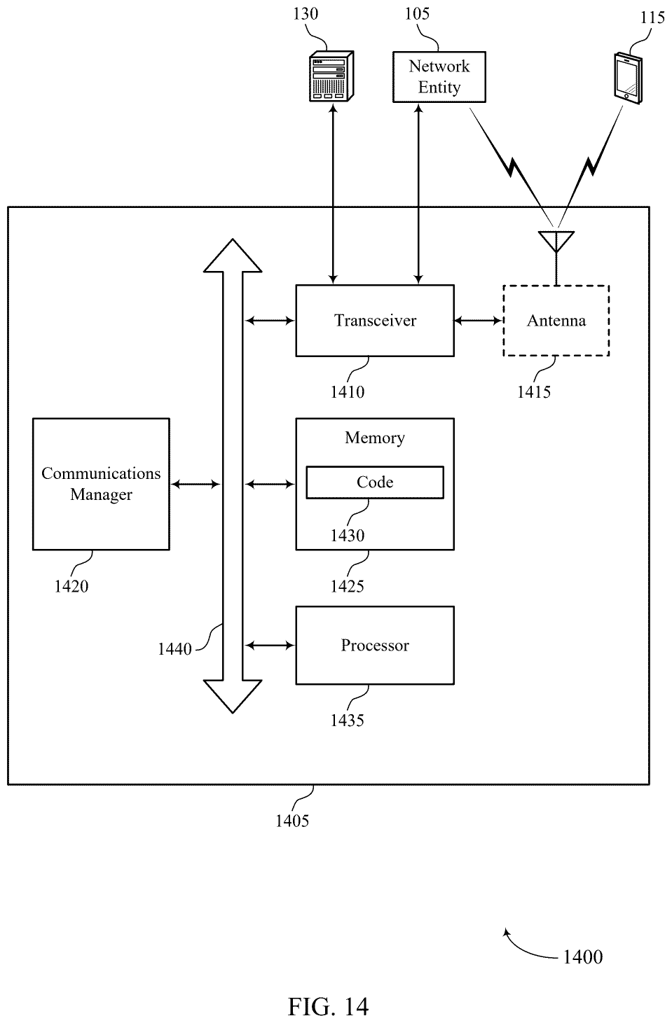

FIG. 14 shows a diagram of a system 1400 including a device 1405 that supports control information associations for polar codes in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting control information associations for polar codes). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

For example, the communications manager 1420 is capable of, configured to, or operable to support a means for communicating a first control information field with a UE, where the first control information field is ordered in a control information format based on a first reliability of a first bit index of a polar code associated with the first control information field. The communications manager 1420 is capable of, configured to, or operable to support a means for communicating a second control information field with the UE, where the second control information field is ordered in the control information format based on a second reliability of a second bit index of the polar code associated with the second control information field, and where the first bit index and the second bit index are included in a set of multiple indices of the polar code that is ordered in an ascending or descending order of reliability.

By including or configuring the communications manager 1420 in accordance with examples as described herein, the device 1405 may support techniques for improved communication reliability, reduced latency, improved user experience related to reduced processing, reduced power consumption, more efficient utilization of communication resources, improved coordination between devices, longer battery life, or improved utilization of processing capability.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of control information associations for polar codes as described herein, or the at least one processor 1435 and the at least one memory 1425 may be otherwise configured to, individually or collectively, perform or support such operations.

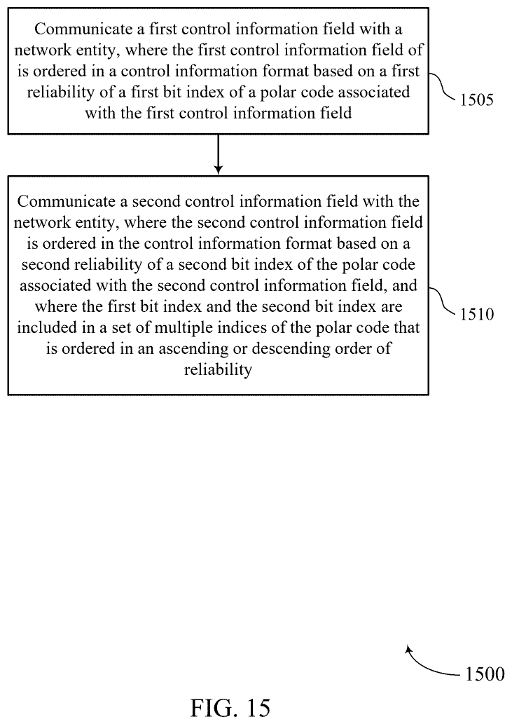

FIG. 15 shows a flowchart illustrating a method 1500 that supports control information associations for polar codes in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include communicating a first control information field with a network entity, where the first control information field is ordered in a control information format based on a first reliability of a first bit index of a polar code associated with the first control information field. The operations of 1505 may be performed in accordance with examples as disclosed herein. In some examples, aspects of the operations of 1505 may be performed by a control information component 925 as described with reference to FIG. 9.

At 1510, the method may include communicating a second control information field with the network entity, where the second control information field is ordered in the control information format based on a second reliability of a second bit index of the polar code associated with the second control information field, and where the first bit index and the second bit index are included in a set of multiple indices of the polar code that is ordered in an ascending or descending order of reliability. The operations of 1510 may be performed in accordance with examples as disclosed herein. In some examples, aspects of the operations of 1510 may be performed by a control information component 925 as described with reference to FIG. 9.

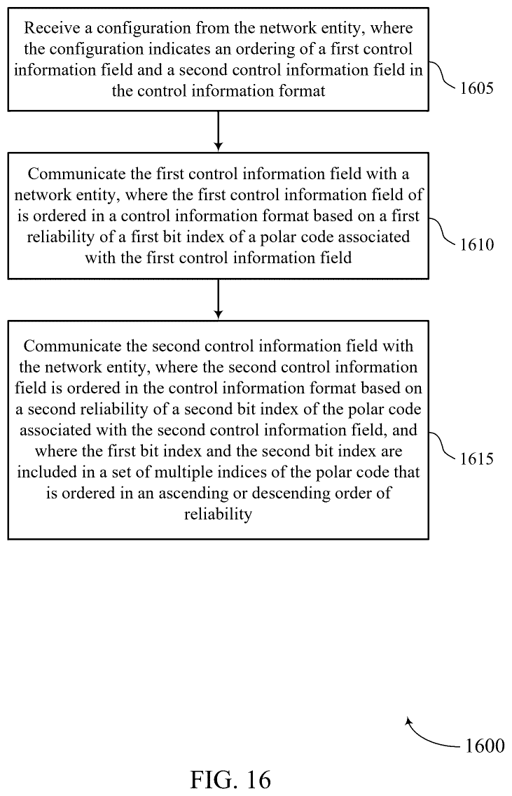

FIG. 16 shows a flowchart illustrating a method 1600 that supports control information associations for polar codes in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving a configuration from the network entity, where the configuration indicates an ordering of a first control information field and a second control information field in the control information format. The operations of 1605 may be performed in accordance with examples as disclosed herein. In some examples, aspects of the operations of 1605 may be performed by a configuration component 930 as described with reference to FIG. 9.

At 1610, the method may include communicating the first control information field with a network entity, where the first control information field is ordered in a control information format based on a first reliability of a first bit index of a polar code associated with the first control information field. For instance, the first control information field may be ordered based on the configuration (e.g., ordered as indicated by the configuration). The operations of 1610 may be performed in accordance with examples as disclosed herein. In some examples, aspects of the operations of 1610 may be performed by a control information component 925 as described with reference to FIG. 9.

At 1615, the method may include communicating the second control information field with the network entity, where the second control information field is ordered in the control information format based on a second reliability of a second bit index of the polar code associated with the second control information field, and where the first bit index and the second bit index are included in a set of multiple indices of the polar code that is ordered in an ascending or descending order of reliability. For instance, the second control information field may be ordered based on the configuration (e.g., ordered as indicated by the configuration). The operations of 1615 may be performed in accordance with examples as disclosed herein. In some examples, aspects of the operations of 1615 may be performed by a control information component 925 as described with reference to FIG. 9.

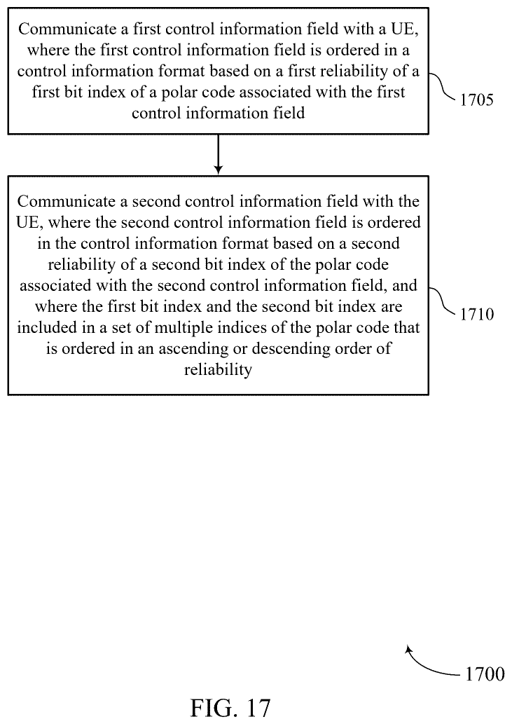

FIG. 17 shows a flowchart illustrating a method 1700 that supports control information associations for polar codes in accordance with one or more aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include communicating a first control information field with a UE, where the first control information field is ordered in a control information format based on a first reliability of a first bit index of a polar code associated with the first control information field. The operations of 1705 may be performed in accordance with examples as disclosed herein. In some examples, aspects of the operations of 1705 may be performed by a control information manager 1325 as described with reference to FIG. 13.

At 1710, the method may include communicating a second control information field with the UE, where the second control information field is ordered in the control information format based on a second reliability of a second bit index of the polar code associated with the second control information field, and where the first bit index and the second bit index are included in a set of multiple indices of the polar code that is ordered in an ascending or descending order of reliability. The operations of 1710 may be performed in accordance with examples as disclosed herein. In some examples, aspects of the operations of 1710 may be performed by a control information manager 1325 as described with reference to FIG. 13.

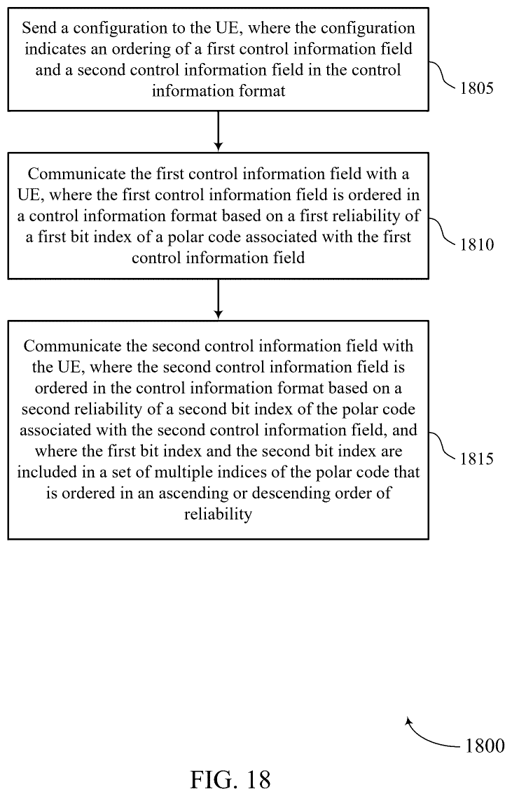

FIG. 18 shows a flowchart illustrating a method 1800 that supports control information associations for polar codes in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include sending a configuration to the UE, where the configuration indicates an ordering of a first control information field and a second control information field in the control information format. The operations of 1805 may be performed in accordance with examples as disclosed herein. In some examples, aspects of the operations of 1805 may be performed by a configuration manager 1330 as described with reference to FIG. 13.

At 1810, the method may include communicating the first control information field with a UE, where the first control information field is ordered in a control information format based on a first reliability of a first bit index of a polar code associated with the first control information field. For instance, the first control information field may be ordered based on the configuration (e.g., ordered as indicated by the configuration). The operations of 1810 may be performed in accordance with examples as disclosed herein. In some examples, aspects of the operations of 1810 may be performed by a control information manager 1325 as described with reference to FIG. 13.

At 1815, the method may include communicating the second control information field with the UE, where the second control information field is ordered in the control information format based on a second reliability of a second bit index of the polar code associated with the second control information field, and where the first bit index and the second bit index are included in a set of multiple indices of the polar code that is ordered in an ascending or descending order of reliability. For instance, the second control information field may be ordered based on the configuration (e.g., ordered as indicated by the configuration). The operations of 1815 may be performed in accordance with examples as disclosed herein. In some examples, aspects of the operations of 1815 may be performed by a control information manager 1325 as described with reference to FIG. 13.

The following provides an overview of aspects of the present disclosure:
Aspect 1: A method for wireless communications by a UE, comprising: communicating a first control information field with a network entity, wherein the first control information field is ordered in a control information format based at least in part on a first reliability of a first bit index of a polar code associated with the first control information field; and communicating a second control information field with the network entity, wherein the second control information field is ordered in the control information format based at least in part on a second reliability of a second bit index of the polar code associated with the second control information field, and wherein the first bit index and the second bit index are included in a plurality of indices of the polar code that is ordered in an ascending or descending order of reliability.
Aspect 2: The method of aspect 1, further comprising: receiving a configuration from the network entity, wherein the configuration indicates an ordering of the first control information field and the second control information field in the control information format.
Aspect 3: The method of aspect 2, wherein the configuration indicates a probability model associated with the first control information field, the probability model indicating a probability for each respective bit of the first control information field to have a value, or a conditional probability that the first control information field has a same value as a previous first control information field.
Aspect 4: The method of any of aspects 2 through 3, wherein the ordering of the first control information field and the second control information field differs from a previous ordering of a previous first control information field and a previous second control information field indicated by a previous configuration.
Aspect 5: The method of aspect 4, wherein the previous configuration is received from another network entity that is different from the network entity from which the configuration is received.
Aspect 6: The method of any of aspects 1 through 5, wherein the first reliability of the first bit index is less than the second reliability of the second bit index, the first control information field indicates a control information format indicator, a MCS, a TDRA, a FDRA, a TPC value, HARQ timing information, a PUCCH resource indicator, an SRS request, an antenna port indicator, or a DMRS sequence indicator, and the second control information field indicates a RV, a NDI, a HARQ process number, or a downlink assignment index.
Aspect 7: The method of any of aspects 1 through 6, further comprising: de-mapping the first control information field from the first bit index; and de-mapping the second control information field from the second bit index, wherein the first control information field is ordered before the second control information field in the control information format, and the first reliability of the first bit index is less than the second reliability of the second bit index.
Aspect 8: The method of any of aspects 1 through 6, further comprising: mapping the first control information field to the first bit index; and mapping the second control information field to the second bit index, wherein the first control information field is ordered before the second control information field in the control information format, and the first reliability of the first bit index is less than the second reliability of the second bit index.
Aspect 9: The method of any of aspects 1 through 7, wherein the first control information field comprises a plurality of bits, and wherein the method further comprises: de-mapping each respective bit of the plurality of bits from respective indices of a subset of the plurality of indices, wherein the respective indices of the subset of the plurality of indices are associated with consecutive reliabilities in the ascending or descending order of reliability.
Aspect 10: The method of any of aspects 1 through 6 and 8, wherein the first control information field comprises a plurality of bits, and wherein the method further comprises: mapping each respective bit of the plurality of bits to respective indices of a subset of the plurality of indices, wherein the respective indices of the subset of the plurality of indices are associated with consecutive reliabilities in the ascending or descending order of reliability.
Aspect 11: The method of aspect 10, wherein each respective bit of the plurality of bits is mapped in an order of the consecutive reliabilities or in an order of the subset of the plurality of indices.
Aspect 12: The method of any of aspects 1 through 11, further comprising: sending an indication of a capability of the UE to utilize the polar code that is ordered in the ascending or descending order of reliability, wherein communicating the first control information field and communicating the second control information field are performed based at least in part on the capability of the UE.
Aspect 13: A method for wireless communications by a network entity, comprising: communicating a first control information field with a UE, wherein the first control information field is ordered in a control information format based at least in part on a first reliability of a first bit index of a polar code associated with the first control information field; and communicating a second control information field with the UE, wherein the second control information field is ordered in the control information format based at least in part on a second reliability of a second bit index of the polar code associated with the second control information field, and wherein the first bit index and the second bit index are included in a plurality of indices of the polar code that is ordered in an ascending or descending order of reliability.
Aspect 14: The method of aspect 13, further comprising: sending a configuration to the UE, wherein the configuration indicates an ordering of the first control information field and the second control information field in the control information format.
Aspect 15: The method of aspect 14, wherein the configuration indicates a probability model associated with the first control information field, the probability model indicating a probability for each respective bit of the first control information field to have a value, or a conditional probability that the first control information field has a same value as a previous first control information field.
Aspect 16: The method of aspect 15, further comprising: determining the probability model based on a plurality of values of previous first control information fields.
Aspect 17: The method of any of aspects 14 through 16, wherein the ordering of the first control information field and the second control information field differs from a previous ordering of a previous first control information field and a previous second control information field indicated by a previous configuration.
Aspect 18: The method of any of aspects 13 through 17, further comprising: de-mapping the first control information field from the first bit index; and de-mapping the second control information field from the second bit index, wherein the first control information field is ordered before the second control information field in the control information format, and the first reliability of the first bit index is less than the second reliability of the second bit index.
Aspect 19: The method of any of aspects 13 through 17, further comprising: mapping the first control information field to the first bit index; and mapping the second control information field to the second bit index, wherein the first control information field is ordered before the second control information field in the control information format, and the first reliability of the first bit index is less than the second reliability of the second bit index.
Aspect 20: The method of any of aspects 13 through 18, wherein the first control information field comprises a plurality of bits, and wherein the method further comprises: de-mapping each respective bit of the plurality of bits from respective indices of a subset of the plurality of indices, wherein the respective indices of the subset of the plurality of indices are associated with consecutive reliabilities in the ascending or descending order of reliability.
Aspect 21: The method of any of aspects 13 through 17 and 19, wherein the first control information field comprises a plurality of bits, and wherein the method further comprises: mapping each respective bit of the plurality of bits to respective indices of a subset of the plurality of indices, wherein the respective indices of the subset of the plurality of indices are associated with consecutive reliabilities in the ascending or descending order of reliability.
Aspect 22: The method of aspect 21, wherein each respective bit of the plurality of bits is mapped in an order of the consecutive reliabilities or in an order of the subset of the plurality of indices.
Aspect 23: The method of any of aspects 13 through 22, further comprising: receiving an indication of a capability of the UE to utilize the polar code that is ordered in the ascending or descending order of reliability, wherein communicating the first control information field and communicating the second control information field are performed based at least in part on the capability of the UE.
Aspect 24: A UE comprising one or more memories storing processor-executable code, and one or more processors coupled with the one or more memories and individually or collectively operable to execute the code to cause the UE to perform a method of any of aspects 1 through 12.
Aspect 25: A UE comprising at least one means for performing a method of any of aspects 1 through 12.
Aspect 26: A non-transitory computer-readable medium storing code the code comprising instructions executable by one or more processors to perform a method of any of aspects 1 through 12.
Aspect 27: A network entity comprising one or more memories storing processor-executable code, and one or more processors coupled with the one or more memories and individually or collectively operable to execute the code to cause the network entity to perform a method of any of aspects 13 through 23.
Aspect 28: A network entity comprising at least one means for performing a method of any of aspects 13 through 23.
Aspect 29: A non-transitory computer-readable medium storing code the code comprising instructions executable by one or more processors to perform a method of any of aspects 13 through 23.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
communicate a first control information field with a network entity, wherein the first control information field is ordered in a control information format based at least in part on a first reliability of a first bit index of a polar code associated with the first control information field; and
communicate a second control information field with the network entity, wherein the second control information field is ordered in the control information format based at least in part on a second reliability of a second bit index of the polar code associated with the second control information field, and wherein the first bit index and the second bit index are included in a plurality of indices of the polar code that is ordered in an ascending or descending order of reliability.

2. The UE of claim 1, wherein the one or more processors are individually or collectively further operable to execute the code to cause the UE to:
receive a configuration from the network entity, wherein the configuration indicates an ordering of the first control information field and the second control information field in the control information format.

3. The UE of claim 2, wherein the configuration indicates a probability model associated with the first control information field, the probability model indicating a probability for each respective bit of the first control information field to have a value, or a conditional probability that the first control information field has a same value as a previous first control information field.

4. The UE of claim 2, wherein the ordering of the first control information field and the second control information field differs from a previous ordering of a previous first control information field and a previous second control information field indicated by a previous configuration.

5. The UE of claim 4, wherein the previous configuration is received from another network entity that is different from the network entity from which the configuration is received.

6. The UE of claim 1, wherein the first reliability of the first bit index is less than the second reliability of the second bit index, the first control information field indicates a control information format indicator, a modulation and coding scheme (MCS), a time domain resource allocation (TDRA), a frequency domain resource allocation (FDRA), a transmit power control (TPC) value, hybrid automatic repeat request (HARQ) timing information, a physical uplink control channel (PUCCH) resource indicator, a sounding reference signal (SRS) request, an antenna port indicator, or a demodulation reference signal (DMRS) sequence indicator, and the second control information field indicates a redundancy version (RV), a new data indicator (NDI), a HARQ process number, or a downlink assignment index.

7. The UE of claim 1, wherein the one or more processors are individually or collectively further operable to execute the code to cause the UE to:
de-mapping the first control information field from the first bit index; and
de-mapping the second control information field from the second bit index, wherein the first control information field be ordered before the second control information field in the control information format, and the first reliability of the first bit index is less than the second reliability of the second bit index.

8. The UE of claim 1, wherein the one or more processors are individually or collectively further operable to execute the code to cause the UE to:
map the first control information field to the first bit index; and
map the second control information field to the second bit index, wherein the first control information field is ordered before the second control information field in the control information format, and the first reliability of the first bit index is less than the second reliability of the second bit index.

9. The UE of claim 1, wherein the first control information field comprises a plurality of bits, and the one or more processors are individually or collectively further operable to execute the code to cause the UE to:
de-map each respective bit of the plurality of bits from respective indices of a subset of the plurality of indices, wherein the respective indices of the subset of the plurality of indices are associated with consecutive reliabilities in the ascending or descending order of reliability.

10. The UE of claim 1, wherein the first control information field comprises a plurality of bits, and the one or more processors are individually or collectively further operable to execute the code to cause the UE to:
map each respective bit of the plurality of bits to respective indices of a subset of the plurality of indices, wherein the respective indices of the subset of the plurality of indices are associated with consecutive reliabilities in the ascending or descending order of reliability.

11. The UE of claim 10, wherein each respective bit of the plurality of bits is mapped in an order of the consecutive reliabilities or in an order of the subset of the plurality of indices.

12. The UE of claim 1, wherein the one or more processors are individually or collectively further operable to execute the code to cause the UE to:
send an indication of a capability of the UE to utilize the polar code that is ordered in the ascending or descending order of reliability, wherein communicating the first control information field and communicating the second control information field are performed based at least in part on the capability of the UE.

13. A network entity, comprising:
one or more memories storing processor-executable code; and
one or more processors coupled with the one or more memories and individually or collectively operable to execute the code to cause the network entity to:
communicate a first control information field with a user equipment (UE), wherein the first control information field is ordered in a control information format based at least in part on a first reliability of a first bit index of a polar code associated with the first control information field; and
communicate a second control information field with the UE, wherein the second control information field is ordered in the control information format based at least in part on a second reliability of a second bit index of the polar code associated with the second control information field, and wherein the first bit index and the second bit index are included in a plurality of indices of the polar code that is ordered in an ascending or descending order of reliability.

14. The network entity of claim 13, wherein the one or more processors are individually or collectively further operable to execute the code to cause the network entity to:
send a configuration to the UE, wherein the configuration indicates an ordering of the first control information field and the second control information field in the control information format.

15. The network entity of claim 14, wherein the configuration indicates a probability model associated with the first control information field, the probability model indicating a probability for each respective bit of the first control information field to have a value, or a conditional probability that the first control information field has a same value as a previous first control information field.

16. The network entity of claim 15, wherein the one or more processors are individually or collectively further operable to execute the code to cause the network entity to:
determine the probability model based on a plurality of values of previous first control information fields.

17. The network entity of claim 14, wherein the ordering of the first control information field and the second control information field differs from a previous ordering of a previous first control information field and a previous second control information field indicated by a previous configuration.

18. The network entity of claim 13, wherein the one or more processors are individually or collectively further operable to execute the code to cause the network entity to:
de-mapping the first control information field from the first bit index; and
de-mapping the second control information field from the second bit index, wherein the first control information field be ordered before the second control information field in the control information format, and the first reliability of the first bit index is less than the second reliability of the second bit index.

19. The network entity of claim 13, wherein the one or more processors are individually or collectively further operable to execute the code to cause the network entity to:
map the first control information field to the first bit index; and
map the second control information field to the second bit index, wherein the first control information field is ordered before the second control information field in the control information format, and the first reliability of the first bit index is less than the second reliability of the second bit index.

20. The network entity of claim 13, wherein the first control information field comprises a plurality of bits, and the one or more processors are individually or collectively further operable to execute the code to cause the network entity to:
de-map each respective bit of the plurality of bits from respective indices of a subset of the plurality of indices, wherein the respective indices of the subset of the plurality of indices are associated with consecutive reliabilities in the ascending or descending order of reliability.

21. The network entity of claim 13, wherein the first control information field comprises a plurality of bits, and the one or more processors are individually or collectively further operable to execute the code to cause the network entity to:
map each respective bit of the plurality of bits to respective indices of a subset of the plurality of indices, wherein the respective indices of the subset of the plurality of indices are associated with consecutive reliabilities in the ascending or descending order of reliability.

22. The network entity of claim 21, wherein each respective bit of the plurality of bits is mapped in an order of the consecutive reliabilities or in an order of the subset of the plurality of indices.

23. The network entity of claim 13, wherein the one or more processors are individually or collectively further operable to execute the code to cause the network entity to:
receive an indication of a capability of the UE to utilize the polar code that is ordered in the ascending or descending order of reliability, wherein communicating the first control information field and communicating the second control information field are performed based at least in part on the capability of the UE.

24. A method for wireless communications by a user equipment (UE), comprising:
communicating a first control information field with a network entity, wherein the first control information field is ordered in a control information format based at least in part on a first reliability of a first bit index of a polar code associated with the first control information field; and
communicating a second control information field with the network entity, wherein the second control information field is ordered in the control information format based at least in part on a second reliability of a second bit index of the polar code associated with the second control information field, and wherein the first bit index and the second bit index are included in a plurality of indices of the polar code that is ordered in an ascending or descending order of reliability.

25. The method of claim 24, further comprising:
receiving a configuration from the network entity, wherein the configuration indicates an ordering of the first control information field and the second control information field in the control information format.

26. The method of claim 24, wherein the first reliability of the first bit index is less than the second reliability of the second bit index, the first control information field indicates a control information format indicator, a modulation and coding scheme (MCS), a time domain resource allocation (TDRA), a frequency domain resource allocation (FDRA), a transmit power control (TPC) value, hybrid automatic repeat request (HARQ) timing information, a physical uplink control channel (PUCCH) resource indicator, a sounding reference signal (SRS) request, an antenna port indicator, or a demodulation reference signal (DMRS) sequence indicator, and the second control information field indicates a redundancy version (RV), a new data indicator (NDI), a HARQ process number, or a downlink assignment index.

27. The method of claim 24, further comprising:
mapping the first control information field to the first bit index; and
mapping the second control information field to the second bit index, wherein the first control information field is ordered before the second control information field in the control information format, and the first reliability of the first bit index is less than the second reliability of the second bit index.

28. A method for wireless communications by a network entity, comprising:
communicating a first control information field with a user equipment (UE), wherein the first control information field is ordered in a control information format based at least in part on a first reliability of a first bit index of a polar code associated with the first control information field; and
communicating a second control information field with the UE, wherein the second control information field is ordered in the control information format based at least in part on a second reliability of a second bit index of the polar code associated with the second control information field, and wherein the first bit index and the second bit index are included in a plurality of indices of the polar code that is ordered in an ascending or descending order of reliability.

29. The method of claim 28, further comprising:
sending a configuration to the UE, wherein the configuration indicates an ordering of the first control information field and the second control information field in the control information format.

30. The method of claim 28, further comprising:
mapping the first control information field to the first bit index; and
mapping the second control information field to the second bit index, wherein the first control information field is ordered before the second control information field in the control information format, and the first reliability of the first bit index is less than the second reliability of the second bit index.
